(19) United States
(12) Patent Application Publication
(10) Pub. No.: US 2013/0286993 A1
(43) Pub. Date: Oct. 31, 2013

(54) APPARATUS FOR TRANSMITTING CONTROL INFORMATION IN A WIRELESS COMMUNICATION SYSTEM AND METHOD THEREOF

(71) Applicants: Hyunwoo Lee, Anyang-si (KR); Jaehoon Chung, Anyang-si (KR); Seunghee Han, Anyang-si (KR)

(72) Inventors: Hyunwoo Lee, Anyang-si (KR); Jaehoon Chung, Anyang-si (KR); Seunghee Han, Anyang-si (KR)

(73) Assignee: LG ELECTRONICS INC., Seoul (KR)

(21) Appl. No.: 13/979,117

(22) PCT Filed: Jan. 9, 2012
(86) PCT No.: PCT/KR2012/000199

§ 371 Date: Jul. 10, 2013

Related U.S. Application Data
(60) Provisional application No. 61/431,059, filed on Jan. 10, 2011.

(30) Foreign Application Priority Data
Jan. 4, 2012 (KR) 10-2012-0001030

(51) Int. Cl. H04W 72/04

(52) U.S. Cl. CPC H04W 72/0406
USPC 370/329

(57) ABSTRACT

The present invention relates to a method of transmitting control information by a user equipment may include the steps of receiving a PDCCH including a CSI request field from the base station via at least one serving cell configured for the user equipment, triggering a report of a 1st control information on an aperiodic CSI to correspond to a value of the received CSI request field, and transmitting the 1st control information and a 2nd control information in a same subframe simultaneously. Moreover, the 1st control information may be transmitted on a PUSCH of the at least one serving cell and the 2nd control information may be transmitted on a PUCCH of the at least one serving cell.

### TECHNICAL FIELD

The present invention relates to a wireless mobile communication system, and more particularly, to an apparatus for transmitting control information and method thereof. The wireless communication system may support carrier aggregation (hereinafter abbreviated CA).

### BACKGROUND ART

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmission power, etc.). For example, the multiple access system may include one of CDMA (code division multiple access) system, FDMA (frequency division multiple access) system, TDMA (time division multiple access) system, OFDMA (orthogonal frequency division multiple access) system, SC-FDMA (single carrier frequency division multiple access) system and the like.

### DISCLOSURE OF THE INVENTION

### Technical Problem

### Technical Solution

Accordingly, the present invention is directed to a wireless communication system that substantially obviates one or more of the problems due to limitations and disadvantages of the related art.

An object of the present invention is to provide an apparatus for transmitting control information in a wireless communication system and method thereof, by which control information may be efficiently transmitted.

Another object of the present invention is to provide a channel format, signal processing method and apparatus therefor, by which control information may be efficiently transmitted.

A further object of the present invention is to provide a method of allocating a resource for carrying control information efficiently and apparatus therefor.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of transmitting control information, which is transmitted to a base station by a user equipment in a wireless communication system, according to one embodiment of the present invention may include the steps of receiving a PDCCH (physical downlink control channel) including a CSI (channel state information) request field from the base station via at least one serving cell configured for the user equipment, triggering a report of a 1^{st} control information on an aperiodic CSI to correspond to a value of the received CSI request field, and transmitting the 1^{st} control information 2^{nd} and a control information in a same subframe simultaneously, wherein the 1^{st} control information is transmitted on a PUSCH (physical uplink shared channel) of the at least one serving cell and wherein the 2^{nd} control information is, transmitted on a PUCCH (physical uplink control channel) of the at least one serving cell.

Preferably, the PUSCH of the at least one serving cell may include, the 1^{st} control information only without a transport block.

Preferably, the 2^{nd} control information may include at least one of a scheduling request (SR) information, an HARQ acknowledgement (ACK) information and an HARQ negative acknowledgement (NACK) information.

Preferably, an information on a BSR (buffer status report) may be transmitted on the PUSCH of the at least one serving cell together with the 1^{st} control information.

Preferably, if the 1^{st} control information, the 2^{nd} information and a 3^{rd} control information on a periodic CSI are simultaneously transmitted in the same subframe, the 1^{st} control information and the 2^{nd} control information may be transmitted only.

Preferably, the 2^{nd} control information may be transmitted using at least one of PUCCH Format 1, PUCCH Format 1a, PUCCH Format 1b and PUCCH Format 3.

To further achieve these and other advantages and in accordance with the purpose of the present invention, a user equipment, which transmits control information to a base station in a wireless communication system, according to another embodiment of the present invention may include a receiving module receiving a PDCCH (physical downlink control channel) including a CSI (channel state information) request field from the base station via at least one serving cell configured for the user equipment, a processor controlling a report of a 1^{st} control information on an aperiodic CSI to be triggered to correspond to a value of the received CSI request field, and a transmitting module transmitting the 1^{st} control information and a 2^{nd} control information in a same subframe simultaneously, wherein the processor controls the 1^{st} control information to be transmitted on a PUSCH (physical uplink shared channel) of the at least one serving cell and wherein the controller controls the 2^{nd} control information to be transmitted on a PUCCH (physical uplink control channel) of the at least one serving cell.

Preferably, the PUSCH of the at least one serving cell may include the 1^{st} control information only without a transport block.

Preferably, the 2^{nd} control information may include at least one of a scheduling request (SR) information, an HARQ acknowledgement (ACK) information and an HARQ negative acknowledgement (NACK) information.

Preferably, the processor may control an information on a BSR (buffer status report) to be transmitted on the PUSCH of the at least one serving cell together with the 1^{st} control information.

Preferably, if the 1^{st} control information, the 2^{nd} information and a 3^{rd} control information on a periodic CSI are simultaneously transmitted in the same subframe, the processor may control the 1^{st} control information and the 2^{nd} control information to be transmitted only.

Preferably, the 2^{nd} control information may be transmitted using at least one of PUCCH Format 1, PUCCH Format 1a, PUCCH Format 1b and PUCCH Format 3.

It is to be understood that both the foregoing general description and the following detailed description are exemplary and explanatory and are intended to provide further explanation of the invention as claimed.

### Advantageous Effects

Accordingly, the present invention provides the following effects and/or advantages.

First of all, the present invention may transmit control information efficiently in a wireless communication system.

Secondly, the present invention may provide a channel format and a signal processing method, thereby transmitting control information efficiently.

Thirdly, the present invention may efficiently allocate a resource for control information transmission.

Effects obtainable from the present invention are non-limited by the above mentioned effect. And, other unmentioned effects can be clearly understood from the following description by those having ordinary skill in the technical field to which the present invention pertains.

It is to be understood by those skilled in the art, to which the present invention pertains, that both the foregoing general description and the following detailed description are exemplary and explanatory and are intended to provide further explanation of the invention as claimed.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram for configuration of a user equipment and a base station, to which the present invention is applicable;

FIG. 2 is a block diagram of a signal processing method for a user equipment to transmit an uplink signal;

FIG. 3 is a block diagram of a signal processing method for a base station to transmit a downlink signal;

FIG. 4 is a lock diagram for SC-FDMA system and OFDMA system, to which the present invention is applicable;

FIG. 5 is a diagram for examples of mapping input symbols to subcarriers in a frequency domain by meeting single carrier property;

FIG. 6 is a block diagram of a signal processing method for mapping DFT process output samples to single carrier in clustered SC-FDMA;

FIG. 7 and FIG. 8 are block diagrams of a signal processing method for mapping DFT process output samples to multi-carrier in clustered SC-FDMA;

FIG. 9 is a block diagram of a signal processing method of segmented SC-FDMA;

FIG. 10 is a diagram for examples of a radio frame structure used in a wireless communication system;

FIG. 11 is a diagram of an uplink subframe structure;

FIG. 12 is a diagram of a structure for determining PUCCH for ACK/NACK transmission;

FIG. 13 and FIG. 14 are diagrams of slot level structures of PUCCH format 1a and 1b for ACK/NACK transmission;

FIG. 15 is a diagram of PUCCH format 2/2a/2b in case of a normal cyclic prefix;

FIG. 16 is a diagram of PUCCH format 2/2a/2b in case of an extended cyclic prefix;

FIG. 17 is a diagram of ACK/NACK channelization for PUCCH format 1a and 1b;

FIG. 18 is a diagram of channelization for a hybrid structure of PUCCH format 1/1a/1b and PUCCH format 2/2a/2b;

FIG. 19 is a diagram for allocation of physical resource block (PRB);

FIG. 20 is a block diagram for concept of managing downlink (DL) component carriers (CCs) in a base station;

FIG. 21 is a block diagram for concept of managing uplink (UL) component carriers (CCs) in a user equipment;

FIG. 22 is a block diagram of concept for one MAC to manage multi-carrier in a base station;

FIG. 23 is a block diagram of concept for one MAC to manage multi-carrier in a user equipment;

FIG. 24 is a block diagram of concept for a plurality of MACs to manage multi-carrier in a base station;

FIG. 25 is a block diagram of concept for a plurality of MACs to manage multi-carrier in a user equipment;

FIG. 26 is a block diagram of another concept for a plurality of MACs to manage multi-carrier in a base station;

FIG. 27 is a block diagram of another concept for a plurality of MACS to manage multi-carrier in a user equipment;

FIG. 28 is a block diagram for asymmetric carrier aggregation in which 5 downlink component carriers (DL CCs) are linked with 1 uplink component carrier (UL CC);

FIGS. 29 to 32 are diagrams of structures of PUCCH format 3 and signal processing methods for the same, to which the present invention is applied;

FIG. 33 is a diagram for a transmission structure of ACK/NACK information using channel selection according to the present invention; and

FIG. 34 is a diagram for a transmission structure of ACK/NACK information using enhanced channel selection according to the present invention.

### BEST MODE

### Mode for Invention

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details.

First of all, techniques, apparatuses (devices) and systems described in the following description may be applicable to various kinds of wireless multiple access systems. For example, the multiple access system may include one of CDMA (code division multiple access), FDMA (frequency division multiple access), TDMA (time division multiple access), OFDMA (orthogonal frequency division multiple access), SC-FDMA (single carrier frequency division multiple access) and the like. CDMA may be implemented by such a wireless or radio technology as UTRA (universal terrestrial radio access), CDMA 2000 and the like. TDMA may be implemented with such a wireless technology as GSM (Global System for Mobile communications), GPRS (General Packet Radio Service), EDGE (Enhanced Data Rates for GSM Evolution) and the like. OFDMA may be implemented with such a wireless technology as IEEE (Institute of Electrical and Electronics Engineers) 802.11 (Wi-Fi), IEEE 802.16 (WiMAX), IEEE 802.20, E-UTRA (Evolved UTRA), etc. UTRAN is a part of UMTS (Universal Mobile Telecommunications System). 3GPP (3rd Generation Partnership Project) LTE (long term evolution) is a part of E-UMTS (Evolved UMTS) that uses E-UTRAN. The 3GPP LTE adopts OFDMA in downlink (DL) and SC-FDMA in uplink (UL). And, LTE-A (LTE-Advanced) is an evolved version of 3GPP LTE. For clarity, the following description mainly concerns a case that the present invention is applied to 3GPP LTE/LTE-A, by which the present invention is non-limited. For instance, although the detailed description of the invent may be based on a wireless communication system corresponding to 3GPP LTE/LTE-A system, it may be applicable to other random wireless communication systems except items unique to 3GPP LTE/LTE-A.

Occasionally, to prevent the present invention from getting vaguer, structures and/or devices known to the public may be skipped or represented as block diagrams centering on the core functions of the structures and/or devices. Wherever possible, the same reference numbers will be used throughout the drawings to refer to the same or like parts.

Besides, in the following description, a terminal may be stationary or may have mobility. And, the terminal may be a common name of a device for transceiving various kinds of data and control informations by communicating with a base station. The terminal may be named one of a user equipment (UE), a mobile station (MS), a mobile terminal (MT), a user terminal (UT), a subscriber station (SS), a wireless device, a personal digital assistant (PDA), a wireless modem, a handheld device and the like.

A base station generally means a fixed station communicating with a terminal or other base stations and exchanges various kinds of data and control informations by communicating with a terminal and other base stations. The base station may be named such a terminology as an evolved-NodeB (eNB), a base transceiver system (BTS), an access point (AP) and the like.

In the present invention, if a specific signal is assigned to one of frame, subframe, slot, carrier and subcarrier, it may mean that a specific signal is transmitted in an interval or timing of frame/subframe/slot via corresponding carrier/subcarrier.

In the present invention, a rank or a transmission rank may mean the number of layers multiplexed with or allocated to one OFDM symbol or one resource element (RE).

In the present invention, PDCCH (Physical Downlink Control CHannel)/PCFICH (Physical Control Format Indicator CHannel)/PHICH (Physical Hybrid automatic retransmit request Indicator CHannel)/PDSCH (Physical Downlink Shared CHannel) may mean a set of resource elements carrying ACK/NACK (ACKnowlegement/Negative ACK)/downlink data for DCI (Downlink Control Information)/CFI (Control Format Indicator)/uplink transmission.

And, PUCCH (Physical. Uplink Control CHannel)/PUSCH (Physical Uplink Shared CHannel)/PRACH (Physical Random Access CHannel) may mean a set of resource elements carrying UCI (Uplink Control Information)/uplink data/random access signal.

In particular, a resource element (RE) allocated or belonging to PDCCH/PCFICH/PHICH/PDSCH/PUCCH/PUSCH/PRACH may be named PDCCH/PCFICH/PHICH/PDSCH/PUCCH/PUSCH/PRACH RE or PDCCH/PCFICH/PHICH/PDSCH/PUCCH/PUSCH/PRACH resource.

Therefore, the expression ‘a user equipment transmits PUCCH/PUSCH/PRACH’ may be used as the same meaning ‘uplink control information/uplink data/random access signal is carried or transmitted on PUSCH/PUCCH/PRACH’. Moreover, the expression ‘a base station transmits PDCCH/PCFICH/PHICH/PDSCH’ may be used as the same meaning ‘downlink control information/downlink data or the like is carried or transmitted on PDCCH/PCFICH/PHICH/PDSCH’

Meanwhile, the expression ‘mapping ACK/NACK information to a specific constellation point’ may be used as the same meaning ‘mapping ACK/NACK information to a specific complex modulation symbol’. And, the expression ‘mapping ACK/NACK information to a specific complex modulation symbol’ may be used as the same meaning ‘modulating ACK/NACK information into a specific complex modulation symbol’.

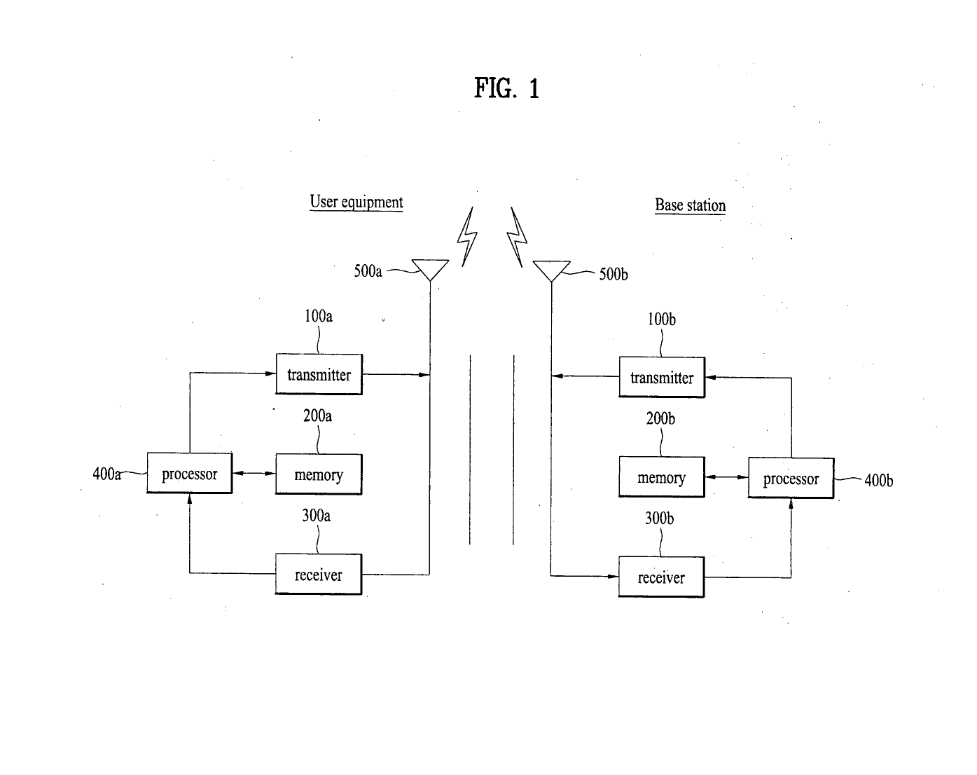

FIG. 1 is a block diagram for configuration of a user equipment and a base station, to which the present invention is applicable. In particular, a user equipment works as a transmitting device in UL or works as a receiving device in DL. On the contrary, a base station works as a receiving device in UL or works as a transmitting device in DL.

Referring to FIG. 1, a user equipment/base station UE/BS) may include an antenna 500a/500b capable of transmitting and receiving information, data, signals and/or messages and the like, a transmitter 100a/100b transmitting information, data, signals and/or messages by controlling the antenna 500a/500b, a receiver 300a/300b receiving information, data, signals and/or messages by controlling the antenna 500a/500b and a memory 200a/200b storing various kinds of informations within a wireless communication system temporarily or permanently. Moreover, the user equipment/base station may further include a processor 400a/400b controlling various components by being operatively connected to the components including the transmitter, the receiver, the memory and the like.

The transmitter 100a, the receiver 300a, the memory 200a and the processor 400a in the user equipment may be implemented with separate chips as independent components, respectively. Alternatively, at least two of the transmitter 100a, the receiver 300a, the memory 200a and the processor 400a in the user equipment may be implemented with a single chip. On the other hand, the transmitter 100b, the receiver 300b, the memory 200b and the processor 400b in the base station may be implemented with separate chips as independent components, respectively. Alternatively, at least two of the transmitter 100b, the receiver 300b, the memory 200b and the processor 400b in the base station may be implemented with a single chip. Alternatively, the transmitter and the receiver may be integrated into a single transceiver in the user equipment or the base station.

The antenna 500a/500b may play a role in externally transmitting a signal generated from the transmitter 100a/100b. And, the antenna 500a/500b may play a role in receiving a signal from outside and then delivering the received signal to the receiver 300a/300b. Moreover, the antenna 500a/500b may be called an antenna port. In this case, the antenna port may correspond to a single physical antenna or may be configured by a combination of a plurality of physical antennas. In case that MIMO (multi-input multi-output) function of transceiving data and the like using a plurality of antennas is supported by a transceiver, at least two antennas may be connected to the transceiver.

The processor 400a/400b may generally control overall operations of various components or modules in the mobile/base station. In particular, the processor 400a/400b may be able to perform various control functions to implement the above-described embodiments of the present invention, a MAC (medium access control) frame variable control function according to service characteristics and propagation environment, a power saving mode function of controlling an idle mode operation, a handover function, an authentication and encryption function and the like. And, the processor 400a/400b may be named one of a controller, a microcontroller, a microprocessor, a microcomputer and the like. Moreover, the processor 400a/400b may be implemented by hardware, firmware, software or a combination thereof.

In case of implementing the present invention using hardware, the processor 400a/400b may be provided with such a configuration to perform the present invention as ASICs (application specific integrated circuits), DSPs (digital signal processors), DSPDs (digital signal processing devices), PLDs (programmable logic devices), FPGAs (field programmable gate arrays), and the like.

In case of implementing the present invention using firmware or software, the firmware or software may be configured to include modules, procedures, and/or functions for performing the functions or operations of the present invention. And, the firmware or software configured to perform the present invention may be driven by the processor 400a/400b in a manner of being loaded in the processor 400a/400b or being saved in the memory 200a/200b.

The transmitter 100a/100b may perform prescribed coding and modulation on a signal and/or data, which is scheduled by the processor 400a/400b or a scheduler connected to the processor 400a/400b and will be then transmitted externally, and may be then able to deliver the coded and modulated signal and/or data to the antenna 500a/500b.

The memory 200a/200b may store programs for processing and control of the processor 400a/400b and may be able to temporarily store input/output information. And, the memory 200a/200b may be utilized as a buffer. Moreover, the memory 200a/200b may include at least one of storage media including a flash type memory, a hard disk type memory, a multimedia card micro type memory, a memory card type memory (e.g., SD memory, XD memory, etc.), a RAM (random access memory), an SRAM (static random access memory), a ROM (read-only memory), an EEPROM (electrically erasable programmable read-only memory), a PROM (programmable read-only memory), a magnetic memory, a magnetic disk, an optical disk and the like.

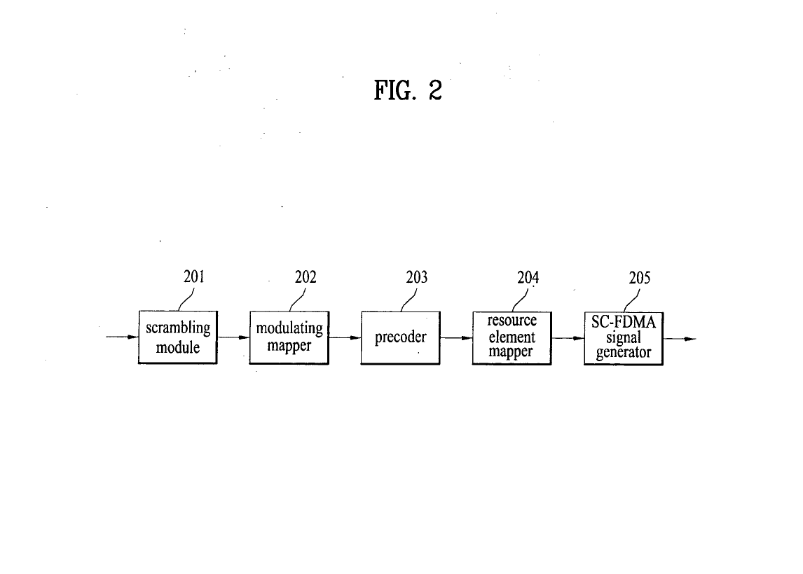

FIG. 2 is a block diagram of a signal processing method for a user equipment to transmit an uplink signal.

Referring to FIG. 2, the transmitter 100a within the user equipment may include a scrambling module 201, a modulating mapper 202, a precoder 203, a resource element mapper 204 and an SC-FDMA signal generator 205.

In order to transmit a UL signal, the scrambling module 201 may scramble a transmission signal using a scrambling signal. The scrambled signal may be inputted to the modulating mapper 202 and may be then modulated into a complex modulation symbol using BPSK (Binary Phase Shift Keying), QPSK (Quadrature Phase Shift Keying) or 16 QAM/64 QAM (Quadrature Amplitude Modulation) scheme in accordance with a type of the transmission signal or a channel status. The complex modulation symbol may be processed by the precoder 203 and may be then inputted to the resource element mapper 204. The resource element mapper 204 may be then able to map the complex modulation symbol to a time-frequency resource element. The above-processed signal may be inputted to the SC-FDMA signal generator 205 and may be then transmitted to a base station via an antenna port.

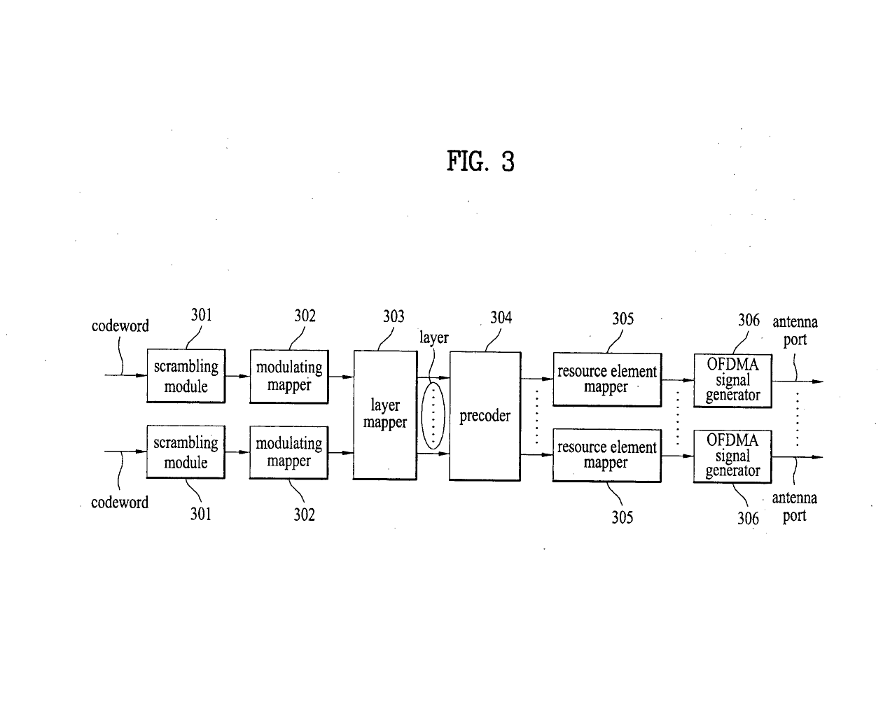

FIG. 3 is a block diagram of a signal processing method for a base station to transmit a downlink signal.

Referring to FIG. 3, the transmitter 100b in the base station may include a scrambling module 301, a modulating mapper 302, a layer mapper 303, a precoder 304, a resource element mapper 305 and an OFDMA signal generator 306.

In order to transmit a DL signal or at least one codeword, a signal or codeword may be modulated into a complex modulation symbol in a manner similar to that shown in FIG. 2. The complex modulation symbol may be mapped to a plurality of layers by the layer mapper 303. Each of the layers is multiplied by a precoding matrix by the precoder 304 and may be then allocated to each transmitting antenna. The above-processed transmission signal per antenna may be mapped to a time-frequency resource element by the resource element mapper 305, may be inputted to the OFDMA (orthogonal frequency division multiple access) signal generator 306, and may be then transmitted via each antenna port.

In case that a user equipment transmits a signal in UL in a wireless communication system, compared to a case that a base station transmits a signal in DL, PAPR (peak-to-average ratio) cause a problem. Hence, as mentioned in the foregoing description with reference to FIG. 2 and FIG. 3, unlike the OFDMA used for DL signal transmission, UL signal transmission adopts SC-FDMA (single carrier-frequency division multiple access).

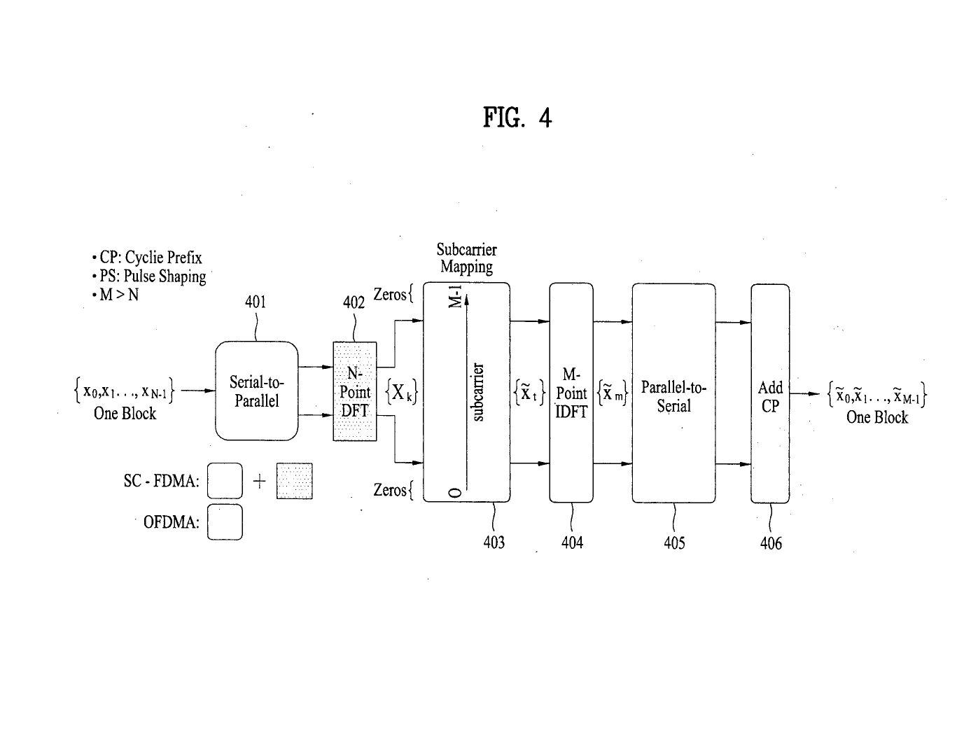

FIG. 4 is a lock diagram for SC-FDMA system and OFDMA system, to which the present invention is applicable. In particular, 3GPP system adopts OFDMA in DL and SC-FDMA in UL.

Referring to FIG. 4, each of a user equipment for UL signal transmission and a base station for DL signal transmission may identically include a serial-to-parallel converter 401, a subcarrier mapper 403, an M-point IDFT module 404 and a CP (cyclic prefix) adding module 406. Yet, the user equipment for transmitting signals by SC-FDMA may further include an N-point. DFT module 402. In particular, the N-point DFT module 402 may offset IDFT processing effect of the M-point IDFT module 404 to some extent, thereby enabling a transmission signal to have single carrier property.

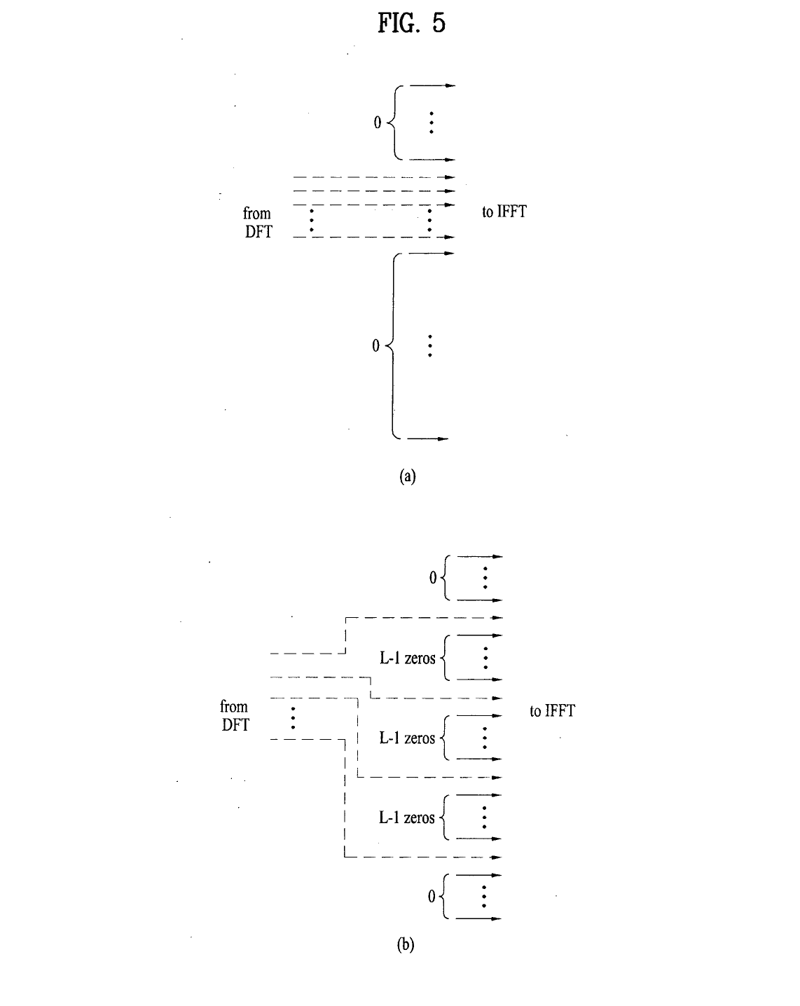

The SC-FDMA should meet the single carrier property. FIG. 5 is a diagram for examples of mapping input symbols to subcarriers in a frequency domain by meeting single carrier property.

Referring to FIG. 5, if a symbol through DFT is allocated to a subcarrier in accordance with one of FIG. 5 (a) and FIG. 5 (b), it may obtain a transmission signal that meets the single carrier property. In this case, FIG. 5 (a) shows a localized mapping scheme and FIG. 5 (b) shows a distributed mapping scheme.

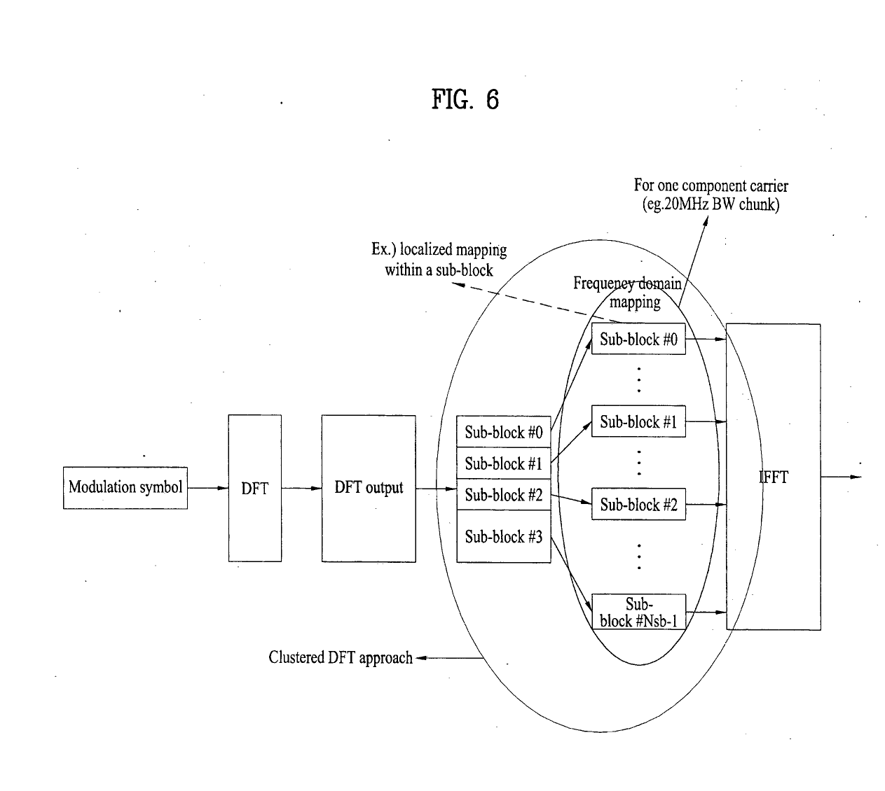

Meanwhile, the transmitter 100a/100b may adopt clustered DFT-s-OFDM. In particular, the clustered DFT-s-OFDM is modification of conventional SC-FDMA and is a signal mapping method including the steps of dividing a signal from a precoder into several subblocks and mapping the subblocks to subcarriers. FIGS. 6 to 8 show examples of mapping an input symbol to a single carrier by DFT-s-OFDM.

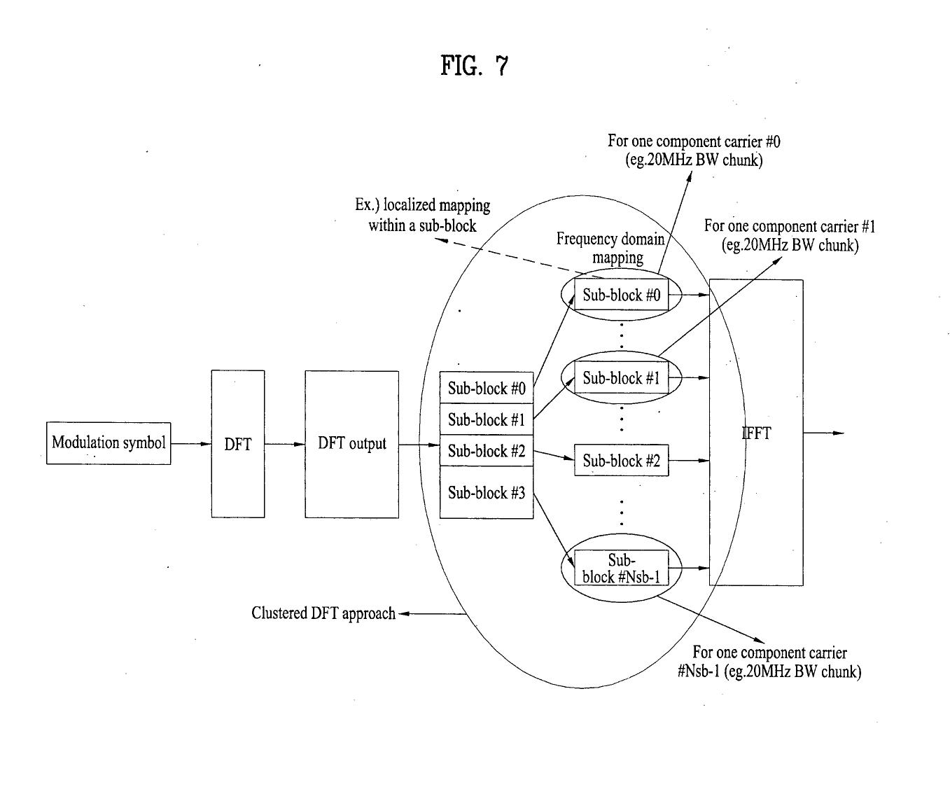

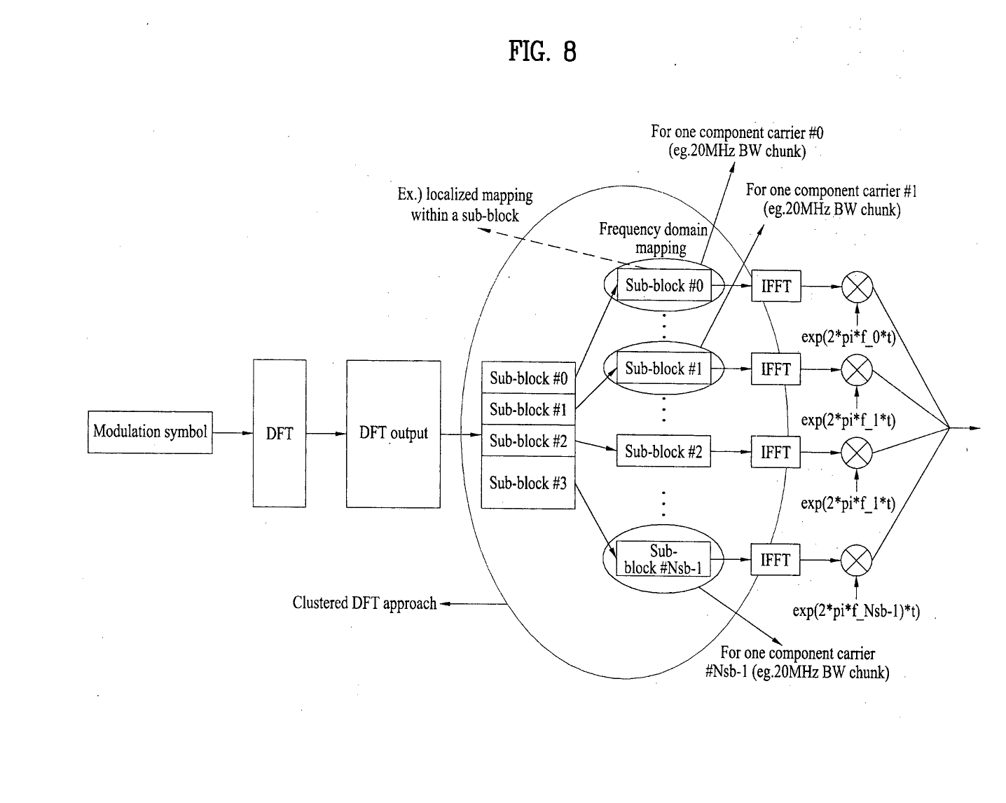

FIG. 6 is a block diagram of a signal processing method for mapping DFT process output samples to single carrier in clustered SC-FDMA. FIG. 7 and FIG. 8 are block diagrams of a signal processing method for mapping DFT process output samples to multi-carrier in clustered SC-FDMA. In particular, FIG. 6 shows an example of applying intra-carrier clustered SC-FDMA. FIG. 7 and FIG. 8 correspond to examples of applying inter-carrier clustered SC-FDMA. Referring to FIG. 7, in a situation that component carriers are contiguously allocated in a frequency domain, when subcarrier spacing between adjacent component carriers is aligned, a signal is generated through a single IFFT block. Referring to FIG. 8, in a situation that component carriers are non-contiguously allocated in a frequency domain, a signal is generated through a plurality of IFFT blocks.

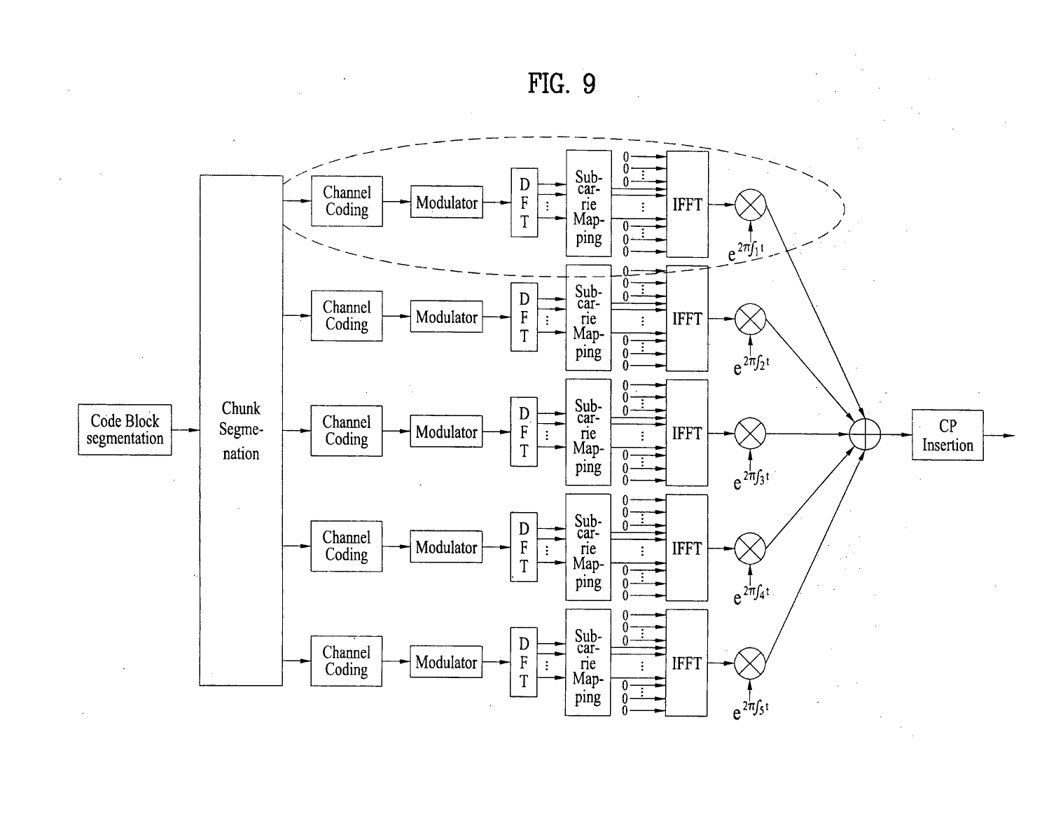

FIG. 9 is a block diagram of a signal processing method of segmented SC-FDMA.

First of all, if IFFTs, of which number is equal to a random number of DFTs, are applied, the configuration of the relation between DFT and IFT becomes one-to-one relation, the segmented SC-FDMA results from simply extending DFT spreading of conventional SC-FDMA and frequency subcarrier mapping configuration of IFFT. And, the segmented SC-FDMA may be expressed as NxSC-FDMA or NxDFT-s-OFDMA. In this specification, they shall be connectively named the segmented SC-FDMA. Referring to FIG. 9, the segmented SC-FDMA may perform a DFT process in a manner of grouping all time-domain modulation symbols into N groups to mitigate the single carrier property condition.

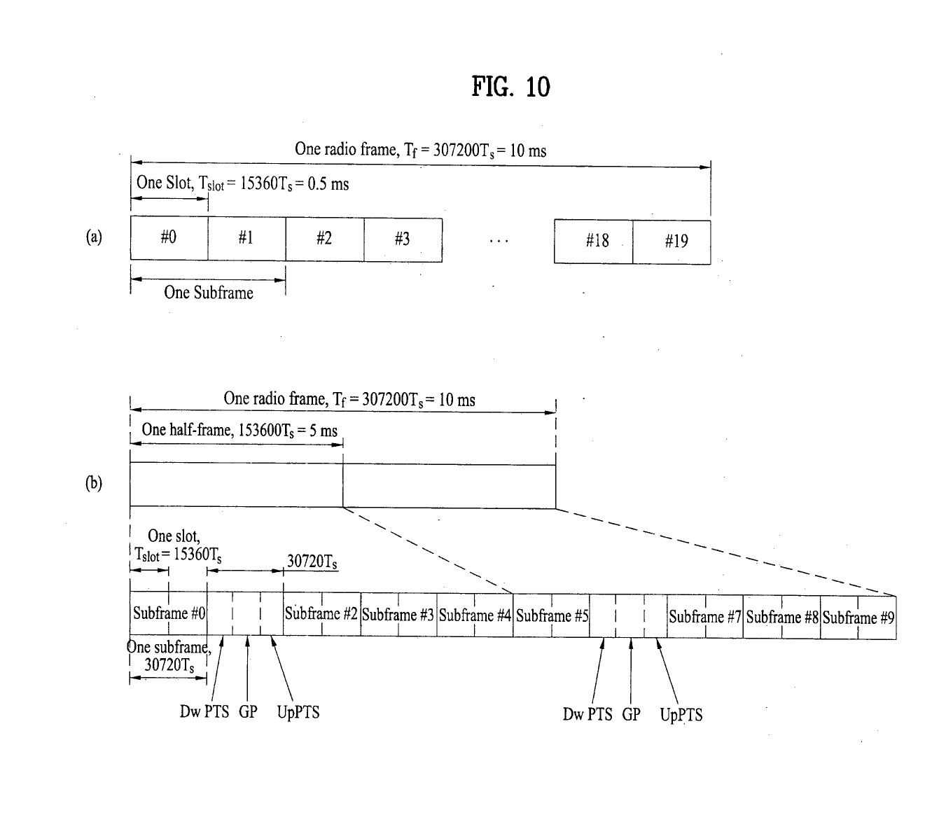

FIG. 10 is a diagram for examples of a radio frame structure used in a wireless communication system. In particular, FIG. 10 (a) shows an example of a radio frame according to a frame structure type 1 (FS-1) of 3GPP LTE/LTEA system. And, FIG. 10 (b) shows an example of a radio frame according to a frame structure type 2 (FS-2) of 3GPP LTE/LTEA system. The frame structure shown in FIG. 10 (a) may be applicable to FDD (frequency division duplex mode) and half FDD (H-FDD) mode. And, the frame structure shown in FIG. 10 (b) may be applicable to TDD (time division duplex) mode.

Referring to FIG. 10, a radio frame used by 3GPP LTE/LTE-A may have a length of 10 ms (307,200 Tₛ) and may include 10 subframes equal to each other in size. 10 Subframes in one radio frame may be numbered. In this case, Tₛ may indicate a sampling time and may be represented as Ts=1/(2,048×15 kHz). Each of the subframes may have a length of 1 ms and may include 2 slots. 20 slots in one radio frame may be sequentially numbered from 0 to 19. Each of the slots may have a length of 0.5 ms. Time for transmitting one subframe may be defined as TTI (transmission time interval). And, a time resource may be identifiable through at least one of a radio frame number (or a radio frame index), a subframe number (or a subframe index), a slot number (or a slot index), and the like.

A radio frame may be configured different according to a duplex mode. For instance, since DL (downlink) transmission and UL (uplink) transmission in FDD mode are distinguished from each other with reference to frequency, a radio frame may include either DL subframe or UL subframe.

On the contrary, since DL (downlink) transmission and UL (uplink) transmission in TDD mode are distinguished from each other with reference to time, subframes in a frame may be divided into DL subframes and UL subframes.

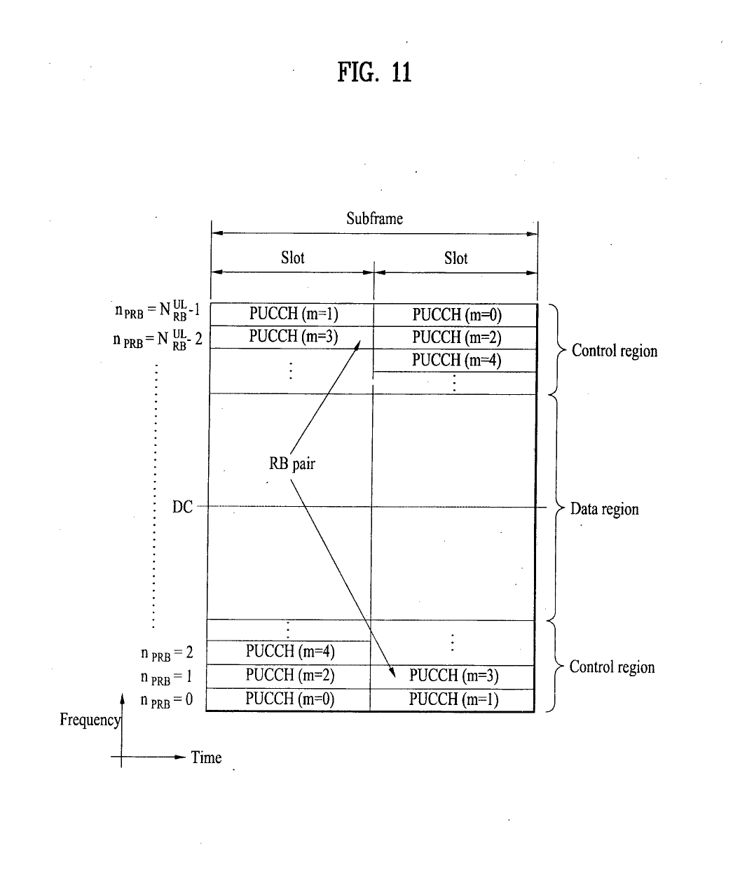

FIG. 11 is a diagram of an uplink subframe structure.

Referring to FIG. 11, UL subframe may be divided into a control region and a data region in a frequency domain. At least one PUCCH (physical uplink control channel) may be allocated to the control region to carry UL control information (UCI). And, at least one PUSCH (physical uplink shared channel) may be allocated to the data region to carry user data. Yet, in case that a user equipment adopts SC-FDMA in LTE Release 8 or LTE Release 9, it may be unable to simultaneously transmit both of PUCCH and PUSCH in a same subframe to maintain the single carrier property.

The UL control information (UCI) carried on PUCCH may differ in size and usage in accordance with PUCCH format. And, a size of the UL control information may vary in accordance with a coding rate. For instance, it may be able to define PUCCH formats as follows.

(1) PUCCH format 1: On-Off keying (OOK) modulation, used for SR (Scheduling Request)

(2) PUCCH format 1a & 1b: Used for ACK/NACK (Acknowledgment/Negative Acknowledgment) information transmission
1) PUCCH format 1a: 1-bit ACK/NACK information modulated by BPSK
2) PUCCH format 1b: 2-bit ACK/NACK information modulated by QPSK

(3) PUCCH format 2: Modulate by QPSK, used for CQI transmission

(4) PUCCH format 2a & PUCCH format 2b: Used for simultaneous transmission of CQI and ACK/NACK information

Table 1 shows a modulation scheme according to PUCCH format and the number of bits per subframe. Table 2 shows the number of reference signals (RS) per slot according to PUCCH format. Table 3 shows SC-FDMA symbol location of RS (reference signal) according to PUCCH format. In Table 1, PUCCH format 2a and PUCCH format 2b correspond to a case of normal cyclic prefix (CP).

TABLE 1

| PUCCH | Modulation | No. of bits |
|---|---|---|
| format | scheme | per subframe |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + BPSK | 22 |

TABLE 2

| PUCCH format | Normal CP | Extended CP |
|---|---|---|
| 1, 1a, 1b | 3 | 2 |
| 2 | 2 | 1 |
| 2a, 2b | 2 | N/A |

TABLE 3

| | SC-FDMA | |
|---|---|---|
| PUCCH | symbol location of RS | |
| format | Normal CP | Extended CP |
| 1, 1a, 1b | 2, 3, 4 | 2, 3 |
| 2, 2a, 2b | 1, 5 | 3 |

In UL subframe, subcarriers distant with reference to DC (direct current) subcarrier may be utilized as a control region. So to speak, subcarriers located at both ends of UL transmission bandwidth may be allocated for transmission of UL control information. The DC subcarrier may be the component remaining instead of being used for signal transmission and may be mapped to a carrier frequency fₒ in a frequency UL transform process by OFDMA/SC-FDMA signal generator.

PUSCCH for one user equipment may be allocated to RB pair in subframe. And, RBs belonging to the RB pair may occupy different subcarriers in two slots, respectively. The above-allocated PUCCH may be represented as ‘RB pair allocated to PUCCH may perform frequency hopping on a slot boundary’. Yet, in case that the frequency hopping is not applied, the RB pair may occupy the same subcarriers in two slots. Irrespective of a presence or non-presence of frequency hopping, since PUCCH for a user equipment is allocated to RB pair in a subframe, the same PUCCH may be transmitted twice in a manner of being transmitted via one RB in each slot in the subframe.

In the following description, the RB pair used for PUCCH transmission in a subframe may be named PUCCH region. And, PUCCH region and code used in the region may be named PUCCH resource. In particular, different PUCCH resources may have different PUCCH regions, respectively, or may have different codes in the same PUCCH region, respectively. For clarity and convenience, PUCCH carrying ACK/NACK information may be named ACK/NACK PUCCH, PUCCH carrying CQI/PMI/RI information may be named CSI (channel state information) PUCCH, and PUCCH carrying SR information may be named SR PUCCH.

A user equipment may receive allocation of PUCCH resource for transmission of UL control information from a base station by an explicit or implicit scheme.

Such UL control information (UCI) as ACK/NACK (ACKnowlegement/negative ACK) information, CQI (Channel Quality Indicator) information, PMI (Precoding Matrix Indicator) information, RI (Rank Information) information, SR (Scheduling Request) information and the like may be carried on a control region of UL subframe.

In a wireless communication system, a user equipment and a base station may exchange signals, data and the like with each other by transmission and reception. In particular, after the base station has transmitted data to the user equipment, the user equipment may decode the received data. If the corresponding data decoding is successful, the user equipment may send ACK to the base station. If the corresponding data decoding is not successful, the user equipment may send NACK to the base station. The above-mentioned data transmission and reception may be identically applicable to a case that the user equipment transmits data to the base station. In 3GPP LTE system, a user equipment receives PDSCH and the like from a base station and then transmits ACK/NACK for the PDSCH through implicit PUCCH determined by the PDCCH carrying scheduling information on the PDSCH. In this case, if the user equipment does not receive data, it may be regarded as DTX (discontinuous transmission) state, handled as a case that there is no received data according to a predetermined rule, or handled in the same manner of NACK (i.e., a case that decoding is not successful despite reception of data).

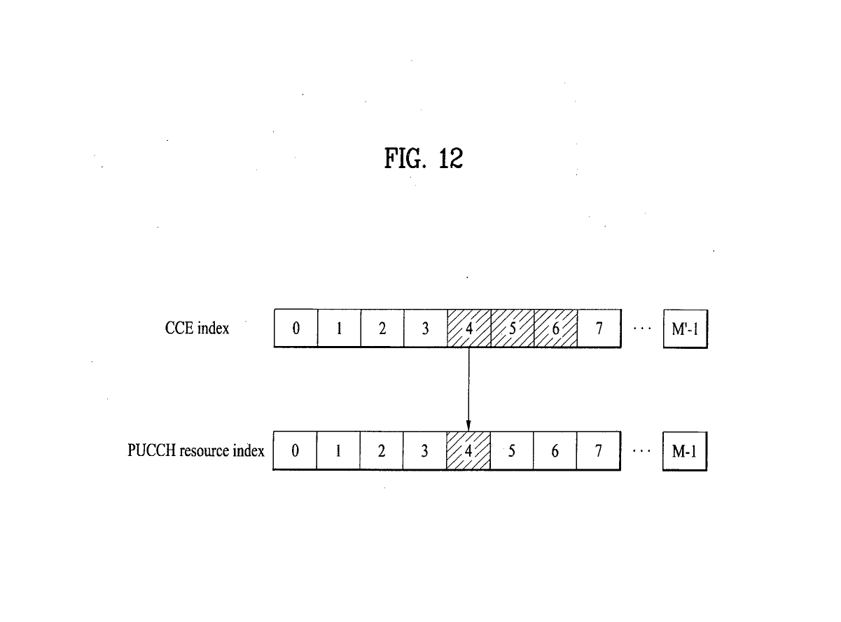

FIG. 12 is a diagram of a structure for determining PUCCH for ACK/NACK transmission.

First of all, PUCCH resource for transmission of ACK/NACK transmission may not be allocated to a user equipment in advance. Instead, a plurality of user equipments in a cell may use a plurality of PUCCH resources in a manner of dividing them each timing point. In particular, PUCCH resource used by a user equipment to transmit ACK/NACK transmission may be determined by an implicit scheme based on PDCCH carrying scheduling information on PDSCH carrying the corresponding DL data. A whole region for transmitting PDCCH in a DL subframe may include a plurality of CCEs (control channel elements). And, PDCCH transmitted to a user equipment may include at least one CCE. The CCE may include a plurality of REGs (resource element groups) (e.g., 9 REGs). One REG may include 4 REs (resource elements) neighboring to one another in a stat that a reference signal (RS) is excluded. A user equipment may transmit ACK/NACK transmission via implicit PUCCH resource induced or calculated by a function of a specific CCE index (e.g., 1^{st} index, lowest CCE index, etc.) among a plurality of indexes of CCEs configuring the received PDCCH.

Referring to FIG. 12, a lowest CCE index of PDCCH may correspond to PUCCH resource index for ACK/NACK transmission. Assuming that scheduling information on PDSCH is transmitted to a user equipment via PDCCH constructed with 4^{th} to 6^{th} CCEs shown in FIG. 12, a user equipment transmits ACK/NACK to a base station via PUCCH resource induced or calculated from an index of the 4^{th} CCE configuring the PDCCH, e.g., the PUCCH resource corresponding to the 4^{th}.

FIG. 12 exemplarily shows a case that maximum M′ CCEs and maximum M PUCCH resources exist in DL subframe and UL subframe, respectively. It may be able to assume a case of ‘M’=M′. Alternatively, the M′ and the M may be designed to have different values, respectively. And, mapping of CCE and PUCCH resource may be set to be overlap with each other. For instance, PUCCH resource index may be defined as follow.

n⁽¹⁾_{PUCCH}=n_{CCE}+N⁽¹⁾_{PUCCH} [Formula 1]

In Formula 1, the n⁽¹⁾_{PUCCH} indicates an index of PUCCH resource to carry ACK/NACK transmission and the N⁽¹⁾_{PUCCH} indicates a signal value delivered from an upper layer. Moreover, the n_{CCE} indicates a smallest value among CCE indexes used for PDCCH transmission.

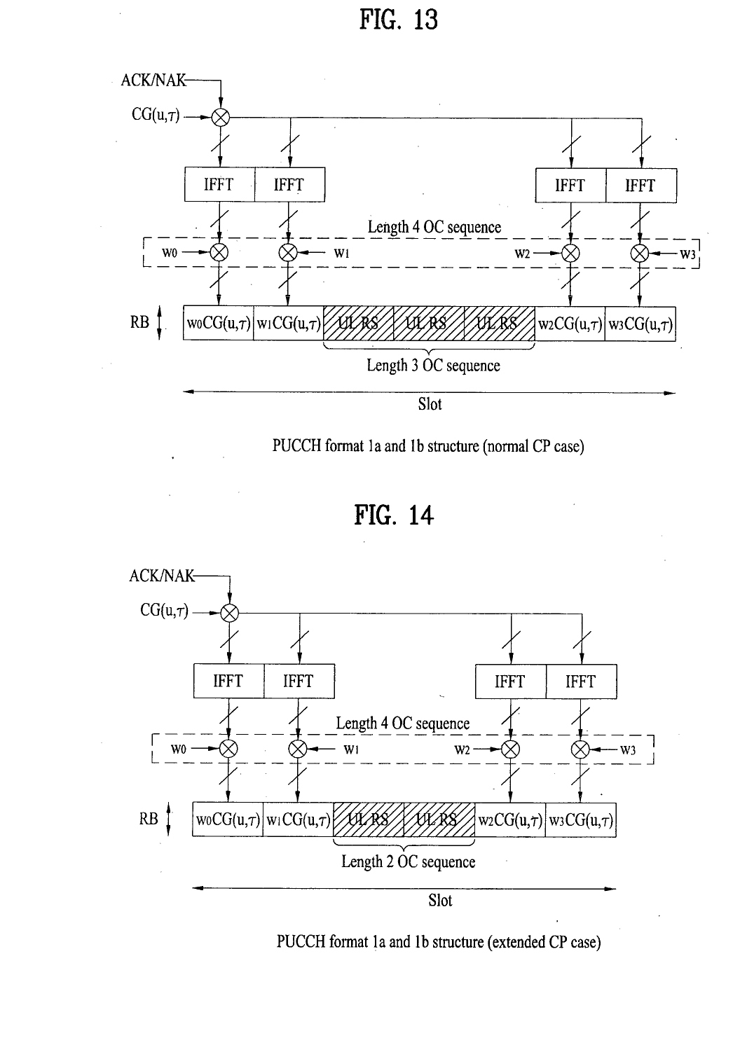

FIG. 13 and FIG. 14 are diagrams of slot level structures of PUCCH format 1a and 1b for ACK/NACK transmission.

In particular, FIG. 13 shows PUCCH format 1a and 1b in case of a normal cyclic prefix. And, FIG. 14 shows PUCCH format 1a and 1b in case of an extended cyclic prefix. According to the PUCCH format 1a and 1b, UL control information of the same content is repeated in a subframe. In a user equipment, ACK/NACK signal is transmitted via different resources constructed with a different cyclic shift (CS) (frequency domain code) and an orthogonal cover (OC) or orthogonal cover code (OCC) (time domain spreading code) of CG-CAZAC (computer-generated constant amplitude zero auto correlation) sequence. For instance, the OC includes Walsh/DFT orthogonal code. If the number of CS and the number of OC are 6 and 3, respectively, total 18 user equipments may be multiplexed within the same PRB (physical resource block) with reference to a single antenna. Orthogonal sequences w0, w1, w2 and w3 may be applicable to a random time domain (after FFT modulation) or a random frequency domain (before FFT modulation). A slot level structure of PUCCH format 1 for transmitting SR (scheduling request) information is identical to that of PUCCH format 1a and 1b but differs from that of the PUCCH format 1a and 1b in modulation scheme only.

For ACK/NACK about the transmission of SR information and semi-persistent scheduling (SPS), PUCCH resource including CS, OC, PRB (physical resource block) and RS (reference signal) may be allocated to a user equipment through signaling. As mentioned in the foregoing description with reference to FIG. 12, for a dynamic ACK/NACK (or ACK/NACK for non-persistent scheduling) feedback and ACK/NACK feedback for PDCCH to indicate SPS cancellation, the PUCCH resource may be implicitly allocated to a user equipment using a smallest CCE index of PDCCH corresponding to PDSCH or PDCCH for SPS cancellation.

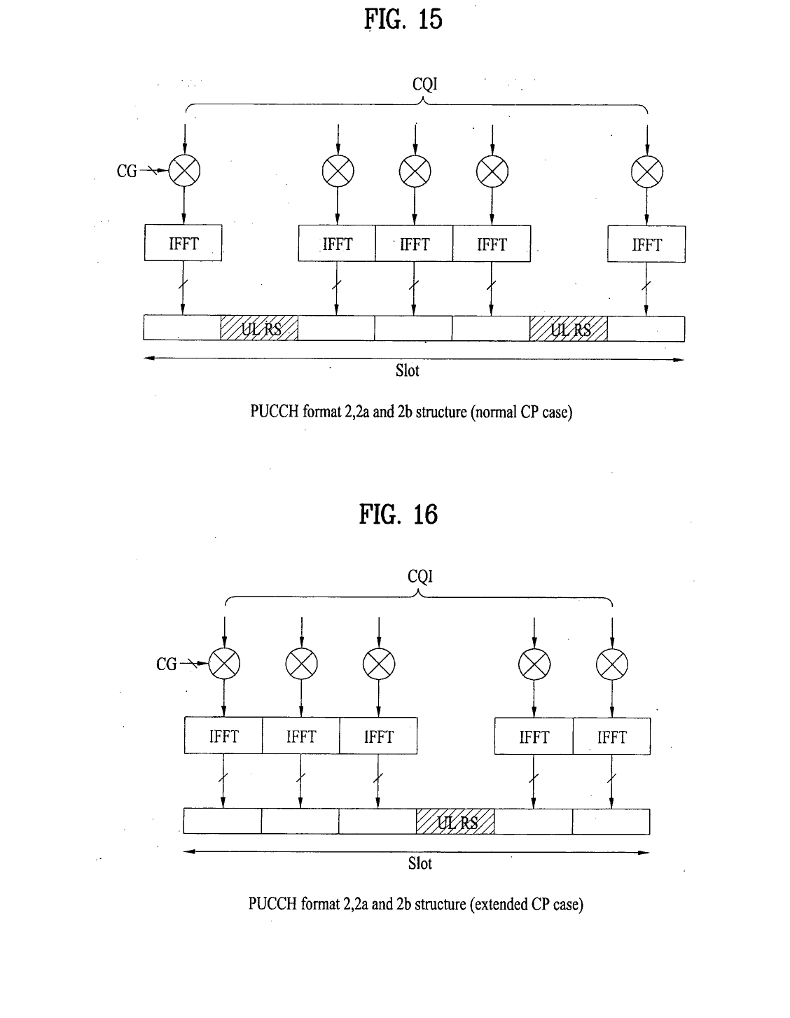

FIG. 15 is a diagram of PUCCH format 2/2a/2b in case of a normal cyclic prefix. And, FIG. 16 is a diagram of PUCCH format 2/2a/2b in case of an extended cyclic prefix.

Referring to FIG. 15 and FIG. 16, in case of a normal CP, a subframe is constructed with 10 QPSK data symbols as well as RS symbol. Each QPSK symbol is spread in a frequency domain by CS and is then mapped to a corresponding SC-FDMA symbol. SC-FDMA symbol level CS hopping may be applied to randomize inter-cell interference. The RS may be multiplexed by CDM using a cyclic shift. For instance, assuming that the number of available CSs is 12, 12 user equipments may be multiplexed in the same PRB. For instance, assuming that the number of available CSs is 6, 6 user equipments may be multiplexed in the same PRB. In brief, a plurality of user equipments in PUCCH format 1/1a/1b and PUCCH format 2/2a/2b may be multiplexed by CS+OC+PRB and CS+PRB, respectively.

Length-4 orthogonal sequence (OC) and length-3 orthogonal sequence for PUCCH format 1/1a/1b are shown in Table 4 and Table 5, respectively:

TABLE 4

| Sequence | Orthogonal |
|---|---|
| index | sequence |
| 0 | [+1 +1 +1 +1] |
| 1 | [+1 −1 +1 −1] |
| 2 | [+1 −1 −1 +1] |

TABLE 5

| Sequence | Orthogonal |
|---|---|
| index | sequence |
| 0 | [1 1 1] |
| 1 | [1 e^{j2π/3} e^{j4π/3}] |
| 2 | [1 e^{j4π/3} e^{j2π/3}] |

Orthogonal sequence (OC) for a reference signal in PUCCH format 1/1a/1b is shown in Table 6.

TABLE 6

| Sequence | Normal | Extended |
|---|---|---|
| index | CP | CP |
| 0 | [1 1 1] | [1 1] |
| 1 | [1 e^{j2π/3} e^{j4π/3}] | [1 −1] |
| 2 | [1 e^{j4π/3} e^{j2π/3}] | N/A |

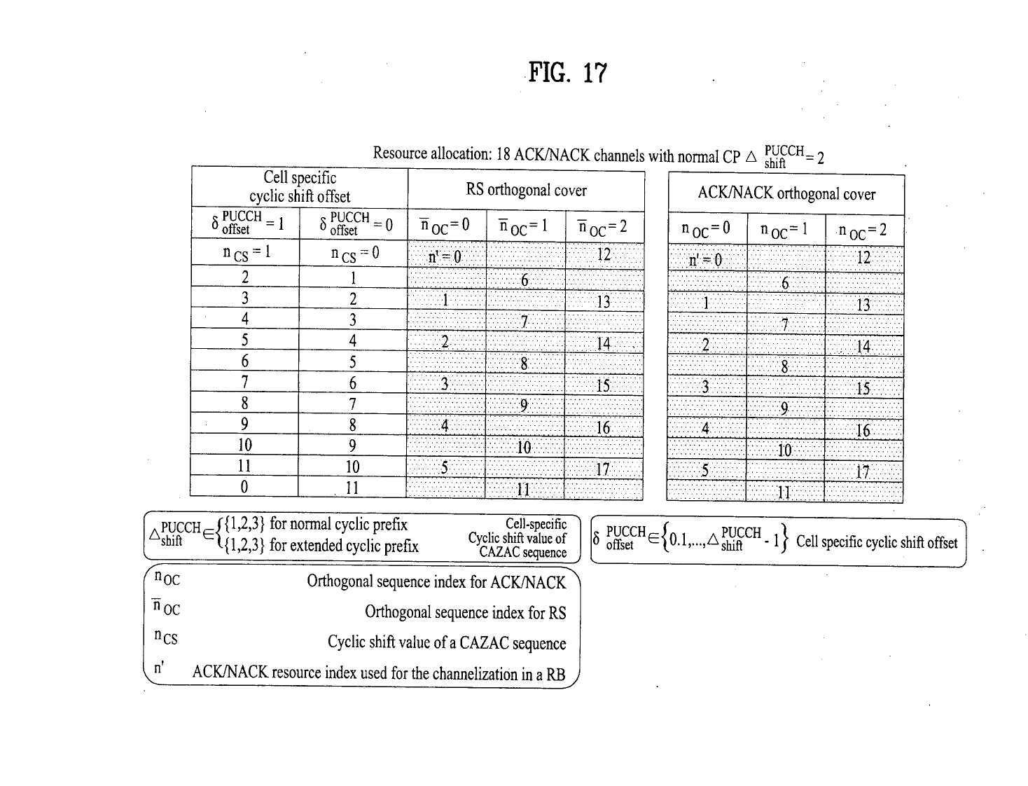

FIG. 17 is a diagram of ACK/NACK channelization for PUCCH format 1a and 1b. In particular, FIG. 14 corresponds to a case of ‘Δ_{shift}^{PUCCH}=2’.

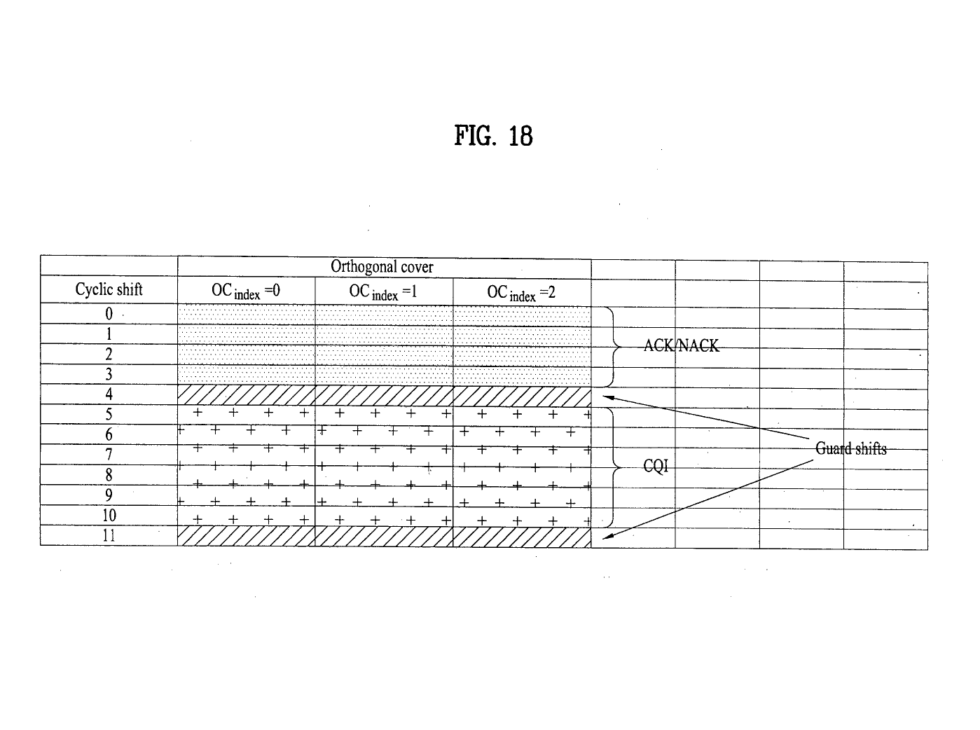

FIG. 18 is a diagram of channelization for a hybrid structure of PUCCH format 1/1a/1b and PUCCH format 2/2a/2b.

Cyclic shift (CS) hopping and orthogonal cover (OC) remapping may be applicable in a following manner.

(1) Symbol-based cell-specific CS hopping for randomization of inter-cell interference)

(2) Slot level CS/OC remapping
1) For inter-cell randomization
2) Slot based access for mapping between ACK/NACK channel and resource (k)

Meanwhile, resource nᵣ for PUCCH format 1/1a/1b may include the following combinations.

(1) CS (=equal to DFT orthogonal code at symbol level) (n_{cs})

(2) OC (orthogonal cover at slot level) (n_{oc})

(3) Frequency RB (Resource Block) (n_{rb})

If indexes indicating CS, OC and RB are set to n_{cs}, n_{oc}, n_{rb}, respectively, a representative index nᵣ may include n_{cs}, n_{oc} and n_{rb}. In this case, the nᵣ may meet the condition of ‘nᵣ=(n_{cs}, n_{oc}, n_{rb})’.

The combination of CQI, PMI, RI, CQI and ACK/NACK may be delivered through the PUCCH format 2/2a/2b. And, Reed Muller (RM) channel coding may be applicable.

For instance, channel coding for uplink CQI in LTE system may be described as follows. First of all, bitstreams a₀, a₁, a₂, a₃, . . . , a_{A-1} may be coded using (20,A) RM code. Table 7 shows a basic sequence for (20,A) code. a₀ and a_{A-1} may indicates MSB (Most Significant Bit) and LSB (Least Significant Bit), respectively. In case of an extended cyclic prefix, maximum transmission bits include 11 bits except a case that QI and ACK/NACK are simultaneously transmitted. After coding has been performed with 20 bits using the RM code, QPSK modulation may be applied. Before the BPSK modulation, coded bits may be scrambled.

TABLE 7

| I | M_{i,0} | M_{i,1} | M_{i,2} | M_{i,3} | M_{i,4} | M_{i,5} | M_{i,6} | M_{i,7} | M_{i,8} | M_{i,9} | M_{i,10} | M_{i,11} | M_{i,12} |
|---|---|---|---|---|---|---|---|---|---|---|---|---|---|
| 0 | 1 | 1 | 0 | 0 | 0 | 0 | 0 | 0 | 0 | 0 | 1 | 1 | 0 |
| 1 | 1 | 1 | 1 | 0 | 0 | 0 | 0 | 0 | 0 | 1 | 1 | 1 | 0 |
| 2 | 1 | 0 | 0 | 1 | 0 | 0 | 1 | 0 | 1 | 1 | 1 | 1 | 1 |
| 3 | 1 | 0 | 1 | 1 | 0 | 0 | 0 | 0 | 1 | 0 | 1 | 1 | 1 |
| 4 | 1 | 1 | 1 | 1 | 0 | 0 | 0 | 1 | 0 | 0 | 1 | 1 | 1 |
| 5 | 1 | 1 | 0 | 0 | 1 | 0 | 1 | 1 | 1 | 0 | 1 | 1 | 1 |
| 6 | 1 | 0 | 1 | 0 | 1 | 0 | 1 | 0 | 1 | 1 | 1 | 1 | 1 |
| 7 | 1 | 0 | 0 | 1 | 1 | 0 | 0 | 1 | 1 | 0 | 1 | 1 | 1 |
| 8 | 1 | 1 | 0 | 1 | 1 | 0 | 0 | 1 | 0 | 1 | 1 | 1 | 1 |
| 9 | 1 | 0 | 1 | 1 | 1 | 0 | 1 | 0 | 0 | 1 | 1 | 1 | 1 |
| 10 | 1 | 0 | 1 | 0 | 0 | 1 | 1 | 1 | 0 | 1 | 1 | 1 | 1 |
| 11 | 1 | 1 | 1 | 0 | 0 | 1 | 1 | 0 | 1 | 0 | 1 | 1 | 1 |
| 12 | 1 | 0 | 0 | 1 | 0 | 1 | 0 | 1 | 1 | 1 | 1 | 1 | 1 |
| 13 | 1 | 1 | 0 | 1 | 0 | 1 | 0 | 1 | 0 | 1 | 1 | 1 | 1 |
| 14 | 1 | 0 | 0 | 0 | 1 | 1 | 0 | 1 | 0 | 0 | 1 | 0 | 1 |
| 15 | 1 | 1 | 0 | 0 | 1 | 1 | 1 | 1 | 0 | 1 | 1 | 0 | 1 |
| 16 | 1 | 1 | 1 | 0 | 1 | 1 | 1 | 0 | 0 | 1 | 0 | 1 | 1 |
| 17 | 1 | 0 | 0 | 1 | 1 | 1 | 0 | 0 | 1 | 0 | 0 | 1 | 1 |
| 18 | 1 | 1 | 0 | 1 | 1 | 1 | 1 | 1 | 0 | 0 | 0 | 0 | 0 |
| 19 | 1 | 0 | 0 | 0 | 0 | 1 | 1 | 0 | 0 | 0 | 0 | 0 | 0 |

Channel coding bits may be generated by Formula 2.

$${b}_{i} = {\sum }_{n = 0}^{A - 1} ( {a}_{n} \cdot {M}_{i , n} ) mod 2 \qquad [ Formula 2 ]$$

In Formula 2, ‘i=0, 1, 2, . . . , B−1’ is met.

Table 8 shows UCI (Uplink Control Information) field for broadband report (single antenna port, transmit diversity) or open loop spatial multiplexing PDSCH CQI feedback.

TABLE 8

| Field | Bandwidth |
|---|---|
| Broadband CQI | 4 |

Table 9 shows UL control information (UCI) field for broadband CQI and PMI feedback. In this case, the field reports closed loop spatial multiplexing PDSCH transmission.

TABLE 9

| | Bandwidth | | | |
|---|---|---|---|---|
| | 2 antenna | | 4 antenna | |
| | ports | | ports | |
| | rank = | rank = | rank = | Rank > |
| Field | 1 | 2 | 1 | 1 |
| Broadband CQI | 4 | 4 | 4 | 4 |
| Spatial difference CQI | 0 | 3 | 0 | 3 |
| PMI (Precoding | 2 | 1 | 4 | 4 |
| Matrix Index) | | | | |

Table 10 shows UL control information (UCI) field for RI feedback to make a broadband report.

TABLE 10

| | Field | | |
|---|---|---|---|
| | Bit widths | | |
| | 2 antenna | 4 antenna | |
| | ports | ports | |
| | 2 antenna | Max. 2 | Max. 4 |
| Field | ports | layers | layers |
| RI (Rank | 1 | 1 | 2 |
| Indication) | | | |

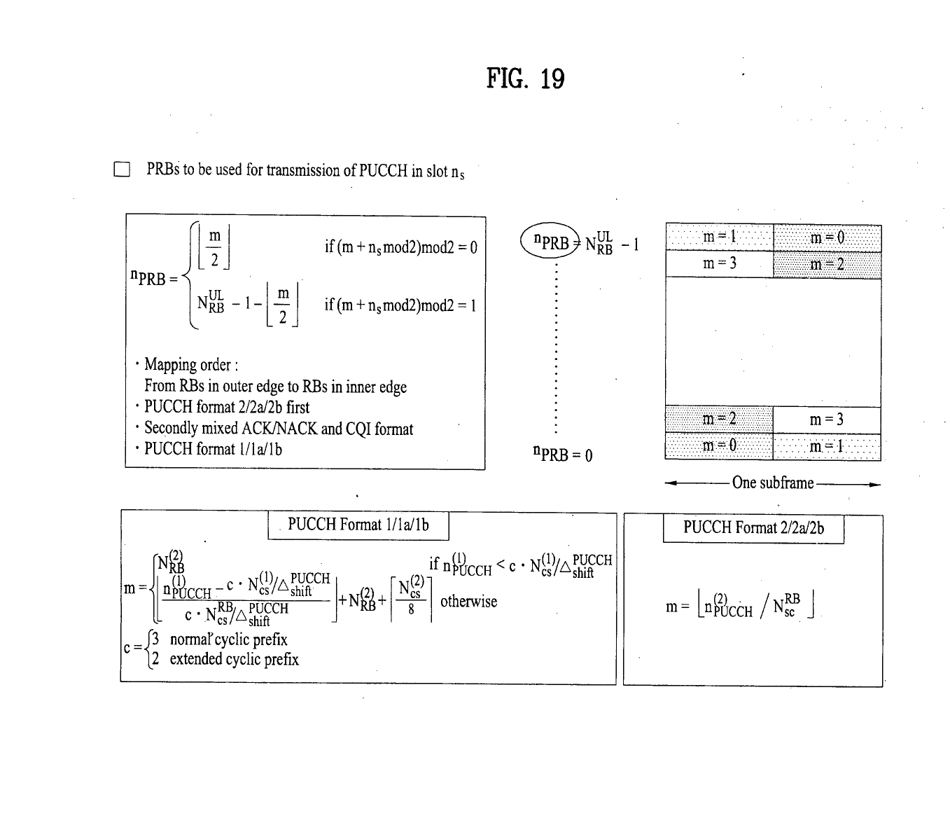

FIG. 19 is a diagram for allocation of physical resource block (PRB). Referring to FIG. 19, PRB may be usable for PUCCH transmission.

Multi-carrier system or CA (carrier aggregation) system may indicate the system that uses a plurality of carriers, each of which has a bandwidth smaller than a target bandwidth, for broadband support in a manner of aggregating the carriers. When a plurality of the carriers, each of which has the bandwidth smaller than the target bandwidth, are aggregated, a band of the aggregated carriers may be limited to a bandwidth used by a previous system for the backward compatibility with the previous system. For instance, the conventional LTE system supports bandwidths of 1.4, 3, 5, 10, 15 and 20 MHz. And, LTE-A (LTE-advanced) system may be able to support a bandwidth greater than 20 MHz using the bandwidths supported by the LTE system. Alternatively, it may be able to support carrier aggregation by defining a new bandwidth irrespective of a bandwidth used by a previous or conventional system. Multi-carrier is the name that may be interchangeably used together with carrier aggregation or bandwidth aggregation. The carrier aggregation may inclusively indicate contiguous carrier aggregation and non-contiguous carrier aggregation. And, the carrier aggregation may inclusively indicate intra-band carrier aggregation and inter-band carrier aggregation as well.

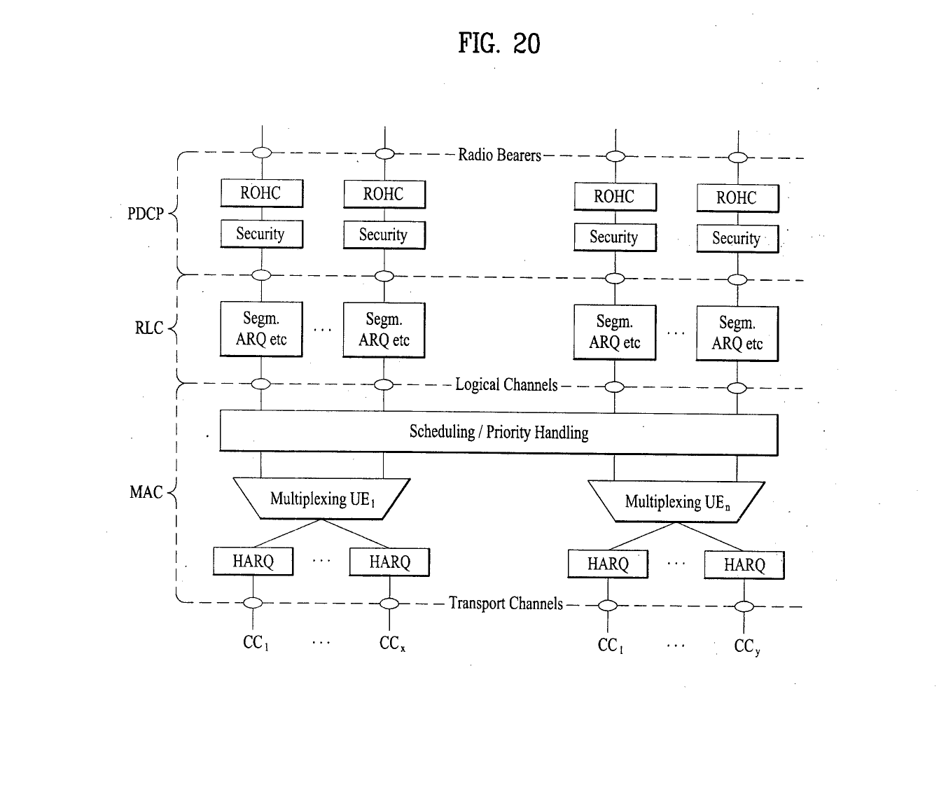

FIG. 20 is a block diagram for concept of managing downlink (DL) component carriers (CCs) in a base station. And, FIG. 21 is a block diagram for concept of managing uplink (UL) component carriers (CCs) in a user equipment. For clarity and convenience of the following description, an upper layer in FIG. 19 or FIG. 20 may be schematized into MAC.

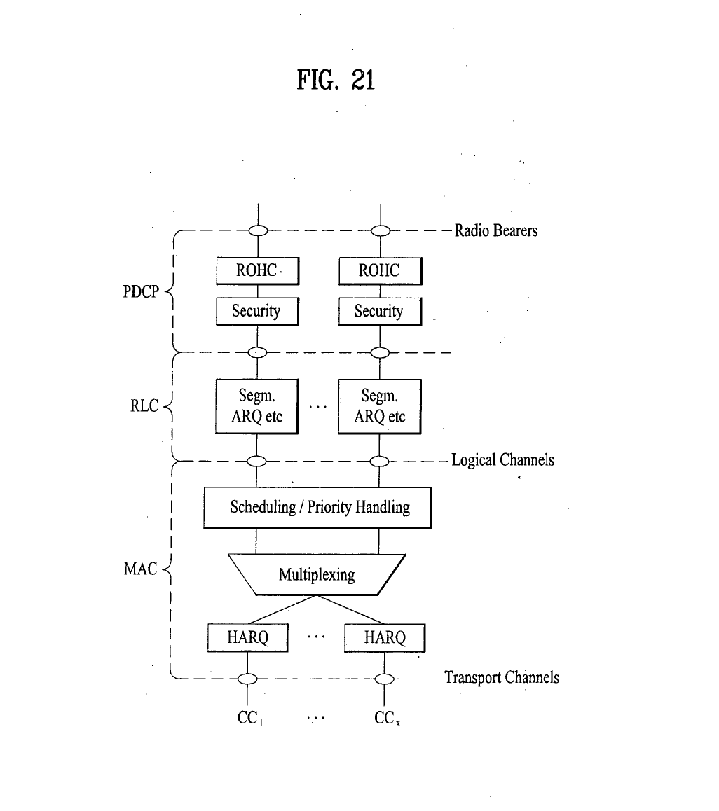

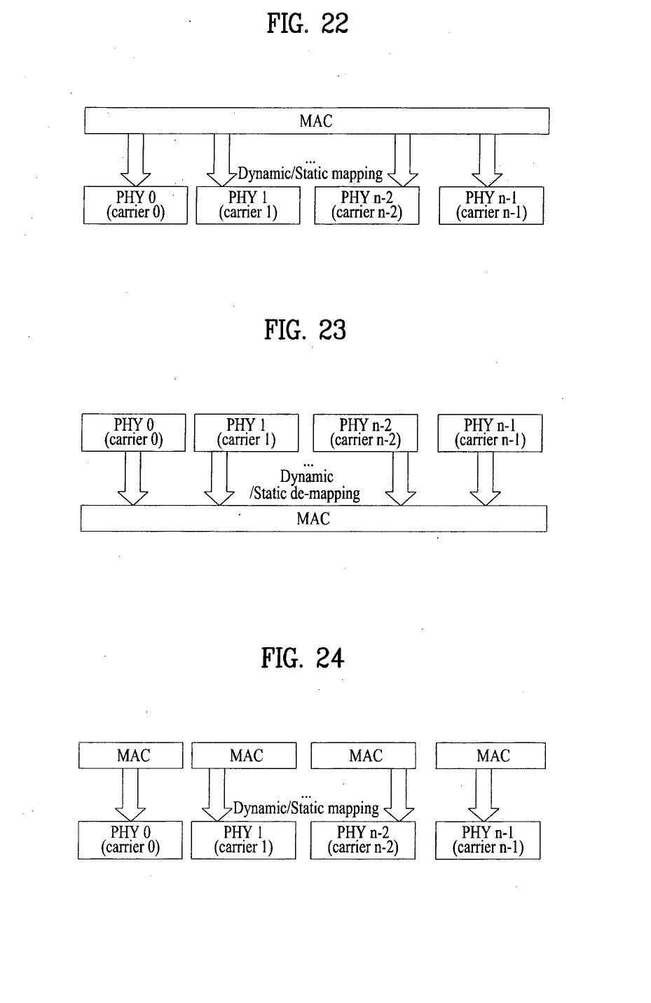

FIG. 22 is a block diagram of concept for one MAC to manage multi-carrier in a base station. And, FIG. 23 is a block diagram of concept for one MAC to manage multi-carrier in a user equipment.

Referring to FIG. 22 and FIG. 23, one MAC may perform transmission and reception by managing and operating at least one or more frequency carriers. Since the frequency carriers managed by one MAC may not need to be contiguous with each other, it may be advantageous that they are more flexible in aspect of resource management. In FIG. 22 and FIG. 23, one PHY may mean one component carrier for clarity and convenience. In this case, it is not necessary for one PHY to mean an independent RF frequency) device. One independent RF device generally means one PHY, which is not mandatory. And, one RF device may include a plurality of PHYs.

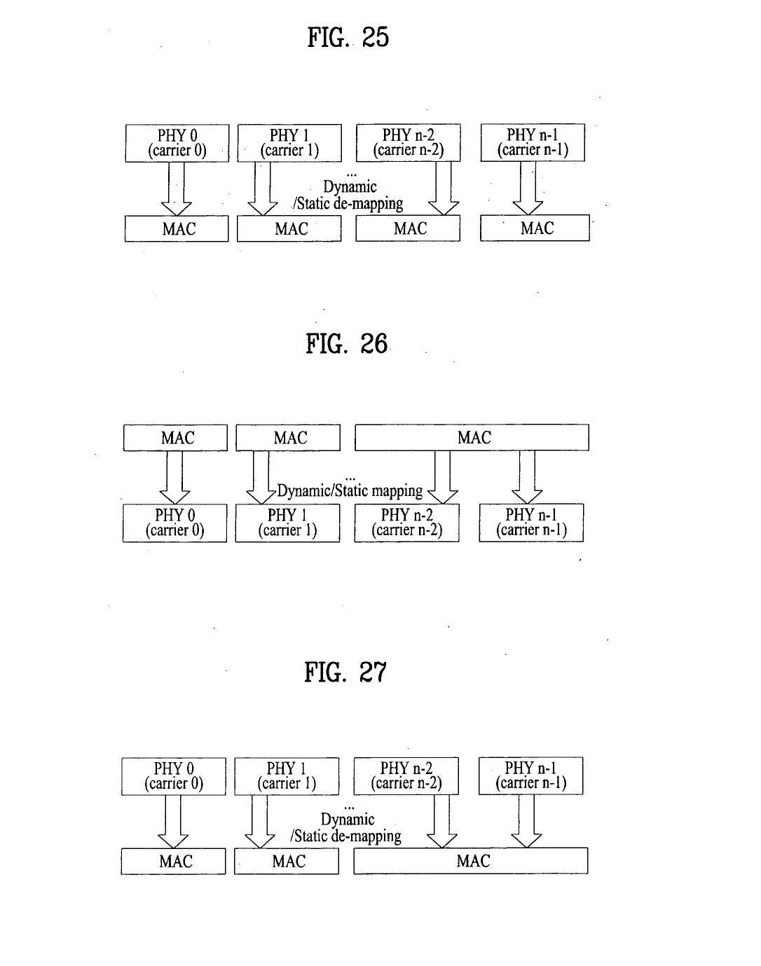

FIG. 24 is a block diagram of concept for a plurality of MACs to manage multi-carrier in a base station. FIG. 25 is a block diagram of concept for a plurality of MACs to manage multi-carrier in a user equipment. FIG. 26 is a block diagram of another concept for a plurality of MACs to manage multi-carrier in a base station. And, FIG. 27 is a block diagram of another concept for a plurality of MACs to manage multi-carrier in a user equipment.

First of all, a plurality of carriers may be controlled by a plurality of MACs instead of one MAC, as shown in FIGS. 24 to 27, unlike the structures shown in FIG. 22 and FIG. 23.

Referring to FIG. 24 and FIG. 25, each MAC may be able to control each carrier by 1:1. Referring to FIG. 26 and FIG. 27, each MAC controls each carrier by 1:1 for some carriers and one MAC may control the rest of at least one or more carriers.

The above-mentioned system may be the system including a plurality of carriers (e.g., 1 to N carriers). And, each of the carriers may be usable contiguously or non-contiguously. This may be applicable irrespective of uplink/downlink. TDD system may be configured to operate a plurality of carriers (e.g., N carriers) in each of which DL/UL transmission is included. In case of the FDD system, asymmetric carrier aggregation, in which the numbers of carriers aggregated in DL and UL or bandwidths of the aggregated carriers are different from each other, may be supportable.

In case that the number of component carriers aggregated in DL is equal to that of component carriers aggregate in UL, it may be possible to configure all component carriers to be compatible with a previous system. Yet, component carriers failing in considering compatibility may not be excluded by the present invention.

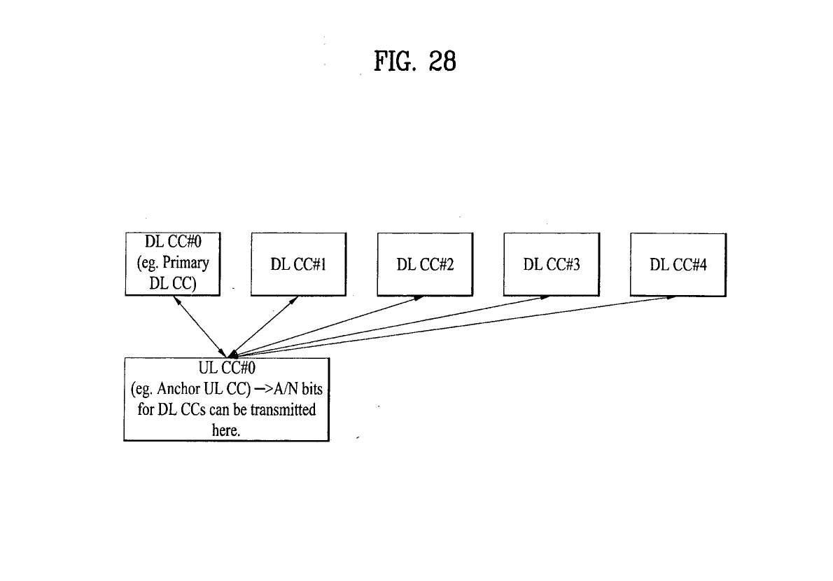

FIG. 28 is a block diagram for asymmetric carrier aggregation in which 5 downlink component carriers (DL CCs) are linked with 1 uplink component carrier (UL CC). The asymmetric carrier aggregation in the drawing may be set in aspect of UL control information (UCI). Specific UCI (e.g., ACK/NACK response) on a plurality of DL CCs may be transmitted in a manner of being gathered in one UL CC. Moreover, in case that a plurality of UL CCs are configured, a specific UCI (e.g., ACK/NACK response for DL CC) may be transmitted via one predetermined UL CC (e.g., primary CC, primary cell, PCell, etc.). For clarity and convenience, assuming that each DL CC may be able to carry maximum 2 codewords and assuming that the number ACKs/NACKs may depend on the maximum number of codewords set per CC (e.g., if the maximum number of codewords set for a specific CC by a base station is 2, although a specific PDCCH uses 1 codeword in CC, the number of the corresponding ACK/NACK may become 2 that is the maximum codeword number in CC), UL ACK/NACK may need at least 2 bits per DL CC in one subframe. In this case, in order to transmit ACK/NACK for data received on 5 DL CCs via one UL CC, ACK/NACK bits may need at least 10 bits in one subframe. In order to separately discriminate DTX (discontinuous transmission) state per DL CC, at least 12 (=5⁶=3125=11.61 bits) bits may be necessary for ACK/NACK transmission. Since the conventional PUCCH format 1a and 1b can send ACK/NACK up to 2 bits, this structure is unable to transmit the extended ACK/NACK information. Although a size of the UL control information is increased due to the carrier aggregation for example, this situation may occur due to one of the incremented number of antennas, TDD system, a presence of backhaul subframe in relay system and the like. Similarly to ACK/NACK, in case that control information associated with a plurality of DL CCs is transmitted via one UL CC, a size of the control information to be transmitted may be increased. For instance, in case that CQI/PMI/RI for a plurality of DL CCs needs to be transmitted, UCI payload may be increased. Meanwhile, although the present invention exemplifies ACK/NACK information on codeword, transport block corresponding to the codeword exists, which is apparently applicable as ACK/NACK information on the transport block. Moreover, although the present invention exemplifies ACK/NACK information on one DL subframe per DL CC for transmission in one UL CC, if it is applied to TDD system, it may be apparently applicable as ACK/NACK information on at least one or more DL subframes per DL CC for transmission in one UL CC.

UL anchor CC, which may be called UL PCC (primary CC), shown in FIG. 28 is the CC carrying PUCCH resource or UCI and may be determine cell-specifically or UE-specifically. For instance, a user equipment may be able to determine a CC attempting an initial random access as a primary CC. In this case, DTX state may be explicitly fed back or may be fed back to share the same state of NACK.

LTE-A may use the concept of cell to manage radio resources. The cell may be defined as the combination of DL resource and UL resource. And, the UL resource may not be mandatory. Hence, the cell may include DL resource only or may include DL resource and UL resource. Linkage between a carrier frequency (or DL CC) of DL resource per cell and a carrier frequency (or UL CC) of UL resource may be indicated by system information. A cell operating on a primary frequency resource (or PCC) may be named a′primary cell (PCell) and a cell operating on a secondary frequency resource (or SCC) may be named a secondary cell (SCell). In particular, the PCell may indicate the cell used by a user equipment to perform an initial connection configuring process or a connection reconfiguring process. The PCell may mean the cell indicated in a handover process. In LTE-A release 10, one PCell may exist only in performing carrier aggregation. The SCell may be configured after completion of RRC connection configuration or may be used to provide an additional radio resource. The PCell and the SCell may be generally called a serving cell. Hence, although a user equipment is in RRC_CONNECTED state, if the user equipment fails in setting up or supporting carrier aggregation, there exists one serving cell including PCell only. On the other hand, when a user equipment is in RRC_CONNECTED state, if the user equipment successfully sets up the carrier aggregation, at least one serving cell exists. And, one PCell and at least one or more SCells are included in a whole serving cell. For the carrier aggregation, after an initial security activating process has been initiated, a network may be able to configure at least one SCell in addition to PCell, which has been configured in an early stage of a connection configuring process, for a user equipment supporting carrier aggregation. Hence, PCC corresponds to one of PCell, a primary (radio) resource and a primary frequency resource, which may be interchangeably usable. Similarly, SCC corresponds to one of SCell, a secondary (radio) resource and a secondary frequency resource, which may be interchangeably usable.

In the following description, a method for transmitting an increased UL control information efficiently may be proposed with reference to the accompanying drawings. In particular, a new PUCCH format, a signal processing method, a resource allocating method and the like may be proposed to transmit an increased UL control information. For the following description, a new PUCCH format proposed by the present invention may be named CA (carrier aggregation) PUCCH format or may be named PUCCH format 3 in consideration that definition of PUCCH format 2 is included in the previous LTE Release 8/9. The technical idea of the PUCCH format proposed by the present invention may be easily applicable to random physical channels (e.g., PUSCH) capable of carrying UL control information using the same or similar method. For instance, an embodiment of the present invention may be applicable to a periodic PUSCH structure for transmitting control information periodically or an aperiodic PUSCH structure for transmitting control information aperiodically.

The following drawings and embodiments mainly relate to, a case of using UCI/RS symbol structure of PUCCH format 1/1a/1b (nor mal CP) of the previous LTE as UCI/RS symbol structure at subframe/slot level applied to PUCCH format 3. Yet, the UCI/RS symbol structure at subframe/slot level in the PUCCH format 3 is defined for example and clarity, by which the present invention is non-limited to a specific structure. In PUCCH format 3 according to the present invention, the number of UCI/RS symbols, locations thereof and the like may be freely modifiable to feet the system design. For instance, PUCCH format 3 according to an embodiment of the present invention may be definable using the RS symbol structure of PUCCH format 1/2a/2b of the previous LTE.

PUCCH format 3 according to an embodiment of the present invention may be usable to carry UL control information of a random type/size. For instance, PUCCH format 3 according to an embodiment of the present invention may be able to transmit such information as HARQ ACK/NACK, CQI, PMI, RI, SR and the like. And, such information may have a payload of a random size. For clarity and convenience, the following drawings and embodiments may be described centering on a case that PUCCH format 3 according to the present invention carries ACK/NACK information.

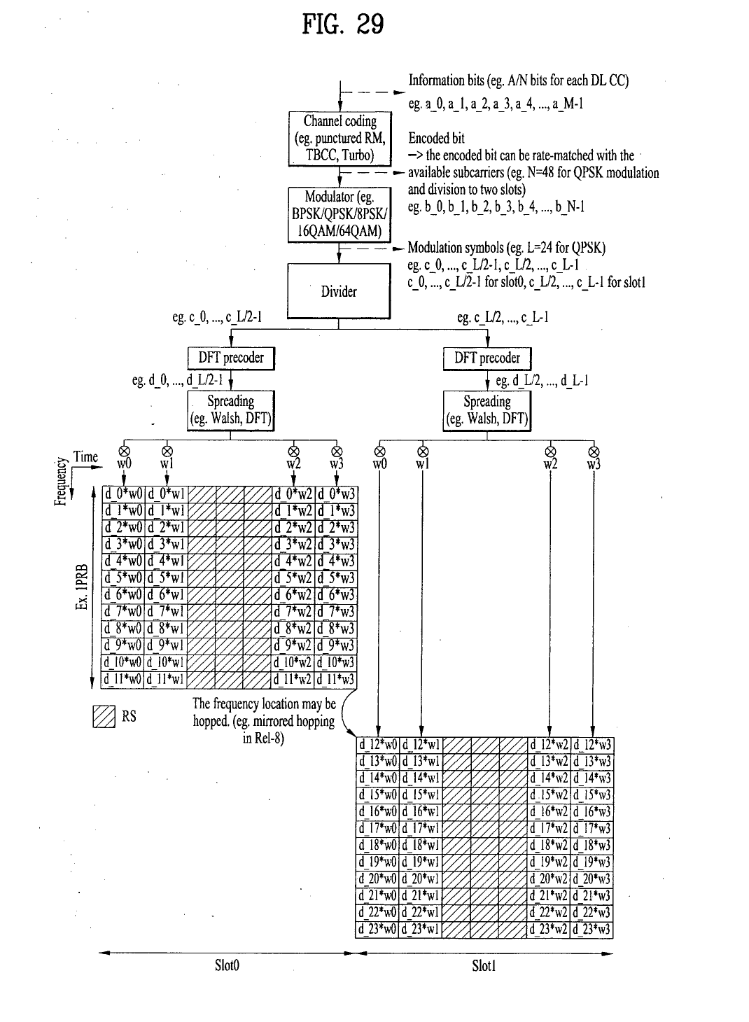

FIGS. 29 to 32 are diagrams of structures of PUCCH format 3 and signal processing methods for the same, to which the present invention is applied. In particular, FIGS. 29 to 32 exemplarily show structures of DFT-based PUCCH format. According to the DFT-based PUCCH format structures, PUCCH is DFT-precoded and may be then transmitted by applying time-domain OC (orthogonal cover) at SC-FDMA level. In the following description, DFT-based PUCCH format may be generally named PUCCH format 3.

FIG. 29 exemplarily shows a structure of PUCCH format 3 using orthogonal code (OC) of ‘SF=4’.

Referring to FIG. 29, a channel coding block may generate coding bits (e.g., encoded bits, coded bits, etc.) (or codeword) b_0, b_1, . . . and b_N−1 by channel-coding transmission bits a_0, a_1, . . . and a_M−1 (e.g., multiple ACK/NACK bits). In this case, the M indicates a size of transmission bits and the N indicates a size of the coding bits. The transmission bits may include multiple ACK/NACK for UL control information (UCI), e.g., a plurality of data (or PDSCH) received via a plurality of DL CCS. In this case, the transmission bits a_0, a_1, . . . and a_M−1 may be joint-coded irrespective of type/number/size of the UCI configuring the transmission bits. For instance, in case that transmission bits include multiple ACK/NACK for a plurality of DL CCs, channel coding may not be performed per DL CC or individual ACK/NACK bit but may be performed on all bit information, from which a single codeword may be generated. And, channel coding is non-limited by this. Moreover, the channel coding may include one of simplex repetition, simplex coding, RM (Reed Muller) coding, punctured RM coding, TBCC (tail-biting convolutional coding), LDPC (low-density parity-check), turbo coding and the like. Besides, coding bits may be rate-matched in consideration of a modulation order and a resource size. A rate matching function may be included as a part of the channel coding block or may be performed via a separate function block. For instance, the channel coding block may obtain a single codeword by performing (32, 0) RM coding on a plurality of control informations and may be then able to perform cyclic buffer rate matching on the obtained single codeword.

A modulator may generate modulation symbols c_0, c_1, . . . and c_L−1 by modulating coding bits b_0, b_1, and b_N−1. In this case, the L indicates a size of modulation symbol. This modulation scheme may be performed in a manner of modifying a size and phase of a transmission signal. For instance, the modulation scheme may include one of n-PSK (Phase Shift Keying), n-QAM (Quadrature Amplitude Modulation) and the like, where n is an integer equal to or greater than 2. In particular, the modulation scheme may include one of BPSK (Binary PSK), QPSK (Quadrature PSK), 8-PSK, QAM, 16-QAM, 64-QAM and the like.

A divider divides the modulation symbols c_0, c_1, . . . and c_L−1 to slots, respectively. A sequence/pattern/scheme for dividing the modulation symbols to the slots may be specially non-limited. For instance, the divider may be able to divide the modulation symbols to the corresponding slots in order from a head to tail (Localized scheme). In dong so, as shown in the drawing, the modulation symbols c_0, c_1, . . . and c_L/2−1 may be divided to the slot 0 and the modulation symbols c_L/2, c_L/2+1, . . . and c_L−1 may be divided to the slot 1. Moreover, the modulation symbols may be divided to the corresponding slots, respectively, by interleaving or permutation. For instance, the even-numbered modulation symbol may be divided to the slot 0, while the odd-numbered modulation symbol may be divided to the slot 1. The modulation scheme and the dividing scheme may be switched to each other in order.

A DFT precoder may perform DFT precoding (e.g., 12-point DFT) on the modulation symbols divided to the corresponding slots to generate a single carrier waveform. Referring to the drawing, the modulation symbols c_0, c_1, . . . and c_L/2−1 divided to the corresponding slot 0 may be DFT-precoded into DFT symbols d_0, d_1, . . . and d_L/2−1, and the modulation symbols c_L/2, c_L/2+1, . . . and c_L−1 divided to the slot 1 may be DFT-precoded into DFT symbols d_L/2, d_L/2+1, . . . and d_L−1. Moreover, the DFT precoding may be replaced by another linear operation (e.g., Walsh precoding) corresponding thereto.

A spreading block may spread the DFT-performed signal at SC-FDMA symbols level (e.g., time domain). The time-domain spreading at the SC-FDMA level may be performed using a spreading code (sequence). The spreading code may include pseudo orthogonal code and orthogonal code. The pseudo orthogonal code may include PN (pseudo noise) code, by which the pseudo orthogonal code may be non-limited. The orthogonal code may include Walsh code and DFT code, by which the orthogonal code may be non-limited. In this specification, for example, the orthogonal code may be mainly described as a representative example of the spreading code for clarity and convenience of the following description. Optionally, the orthogonal code may be substituted with the pseudo orthogonal code. A maximum value of a spreading code size (or a spreading factor: SF) may be limited by the number of SC-FDAM symbols used for control information transmission. For example, in case that 4 SC-FDMA symbols are used in one slot for control information transmission, 4 orthogonal codes w0, w1, w2 and w3 of length 4 may be used per slot. The SF may mean a spreading degree of the control information and may be associated with a multiplexing order or an antenna multiplexing order of a user equipment. The SF may be variable like 1, 2, 3, 4, . . . and the like in accordance with a requirement of a system. The SF may be defined in advance between a base station and a user equipment. And, the SF may be notified to a user equipment via DL control information (DCI) or RRC signaling. For instance, in case of puncturing one of SC-FDMA symbols for control information to transmit SRS, it may be able to apply a spreading code, of which SF is reduced (e.g., SF=3 instead of SF=4), to control information of a corresponding slot.

The signal generated through the above-described process may be mapped to subcarrier within the PRB and may be then transformed into a time-domain signal through IFFT. CP may be added to the time-domain signal. The generated SC-FDMA symbol may be then transmitted via RF stage.

Assuming a case of transmitting ACK/NACK for 5 DL CCs, each process is exemplified in detail as follows. First of all, in case that each DL CC is able to carry PDSCH, corresponding ACK/NACK bits may be 12 bits in case of including DTX state. Assuming QPSK modulation and time spreading of ‘SF=4’, a coding block size (after rate matching) may include 48 bits. Coding bits may be modulated into 24 QPSK symbols and the generated QPSK symbols may be divided to the corresponding slots in a manner that 12 of them are divided to each of the slots. The 12 QPSK symbols in each of, the slots may be transformed into 12 DFT symbols through 12-point DFT operation. The 12 DFT symbols in each of the slots may be spread and mapped to 4 SC-FDMA symbols using the spreading code ‘SF=4’ in the time domain. Since 12 bits are carried on [2 bits*12 subcarriers*8 SC-FDMA symbols], a coding rate may become 0.0625 (=12/192). Moreover, if SF=4, it may be able to multiplex maximum user equipments of 4 users per 1PRB.

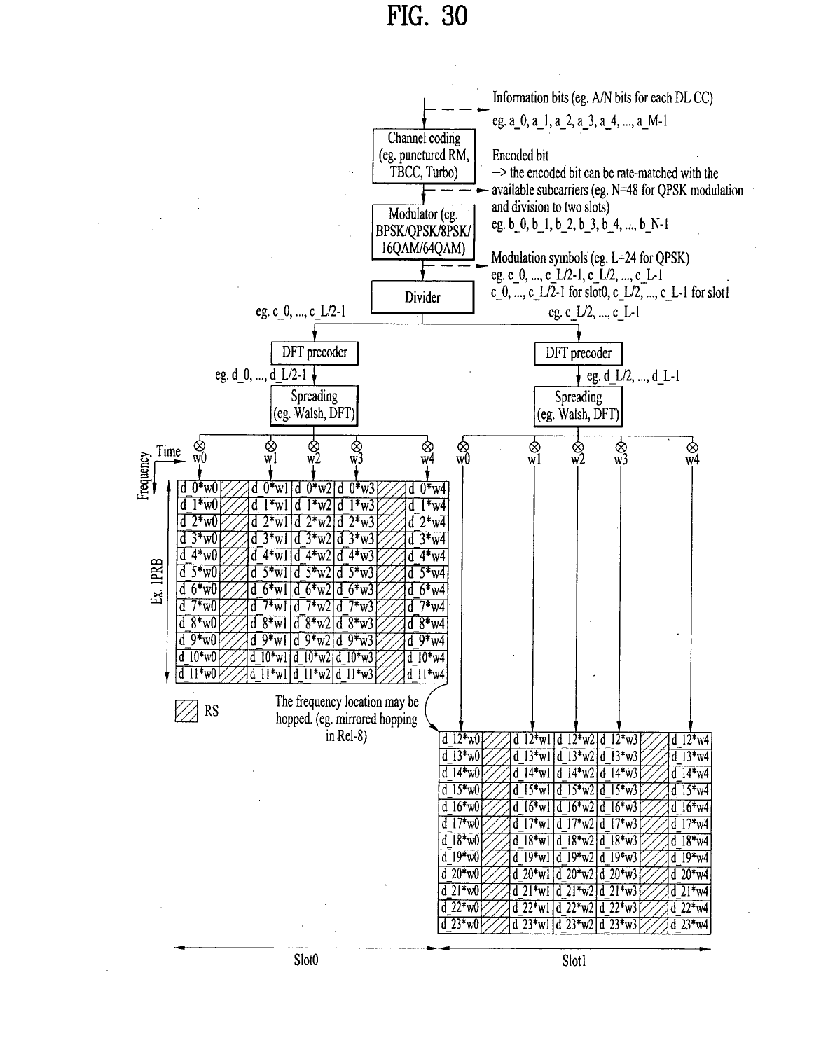

FIG. 30 exemplarily, shows a structure of PUCCH format 3 using orthogonal code (OC) of ‘SF=5’.

Referring to FIG. 30, a basic signal processing method may be equal to the former method described with reference to FIG. 29. FIG. 30 differs from FIG. 29 in the numbers/locations of UL control information (UCI) SC-FDMA symbols and RS SC-FDMA symbols. In this case, a spreading block may apply to a front stage of a DFT precoder.

In FIG. 3, RS may succeed to the structure of LTE system. For instance, a cyclic shift may be applicable to a basic sequence. A multiplexing capacity of a data part may become 5 due to ‘SF=5’. Yet, a multiplexing capacity of an RS part may be determined according to a cyclic shift interval Δ_{shift}^{PUCCH}. For instance, the multiplexing capacity may be given as 12/Δ_{shift}^{PUCCH}. In this case, a multiplexing capacity for Δ_{shift}^{PUCCH}=1, a multiplexing capacity for Δ_{shift}^{PUCCH}=2 and a multiplexing capacity for Δ_{shift}^{PUCCH}=3 may become 12, 6 and 4, respectively. In FIG. 30, the multiplexing capacity of the data part becomes 5 due to SF=. Yet, if the multiplexing capacity of the RS becomes 4 in case of Δ_{shift}^{PUCCH}, total multiplexing capacity may be limited to 4 corresponding to a smaller value of the two.

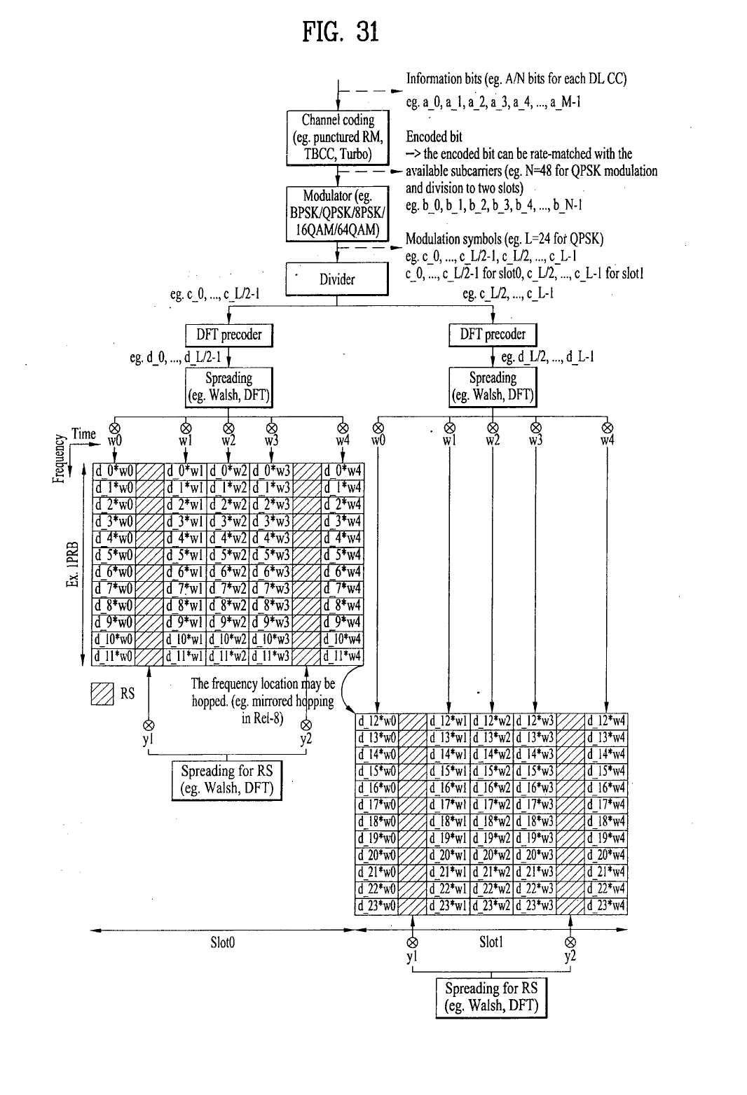

FIG. 31 exemplarily shows a structure of PUCCH format 3 that may increase multiplexing capacity at slot level.

First of all, it may be able to increase total multiplexing capacity by applying the SC-FDMA symbol level spreading described with reference to FIG. 29 and FIG. 30 to RS. Referring to FIG. 31, if Walsh cover (or DFT code cover) is applied with a slit, multiplexing capacity may be doubled. Hence, the multiplexing capacity may become 8 despite Δ_{shift}^{PUCCH} not to decrease multiplexing capacity in data interval. In FIG. 31, ‘[y1 y2]=[1 1]’, ‘[y1 y2]=[1 −1]’ or linear transform type thereof (e.g., [j j], [j −j], [1 j], [1 −j], etc.) may be usable as orthogonal cover code for RS.

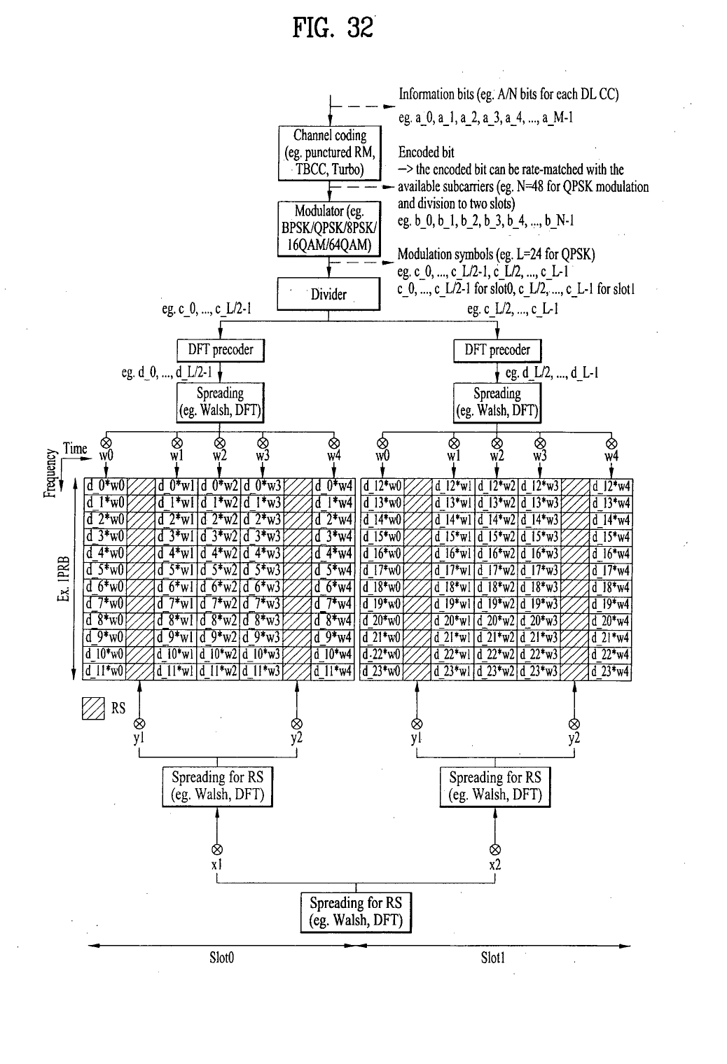

FIG. 32 exemplarily shows a structure of PUCCH format 3 that may increase multiplexing capacity at subframe level.

Referring to FIG. 32, if frequency hopping is not applied at slot level, it may be able to double the multiplexing capacity again by applying Walsh cover by slot unit. In doing so, as mentioned in the foregoing description, it may be able to use ‘[x1 x2] (=[1 1] or [1 −1])’ as the orthogonal cover code. And, its modified form may be usable as well.

For reference, the processing process for PUCCH format 3 may not be bound by the orders shown in FIGS. 29 to 32.

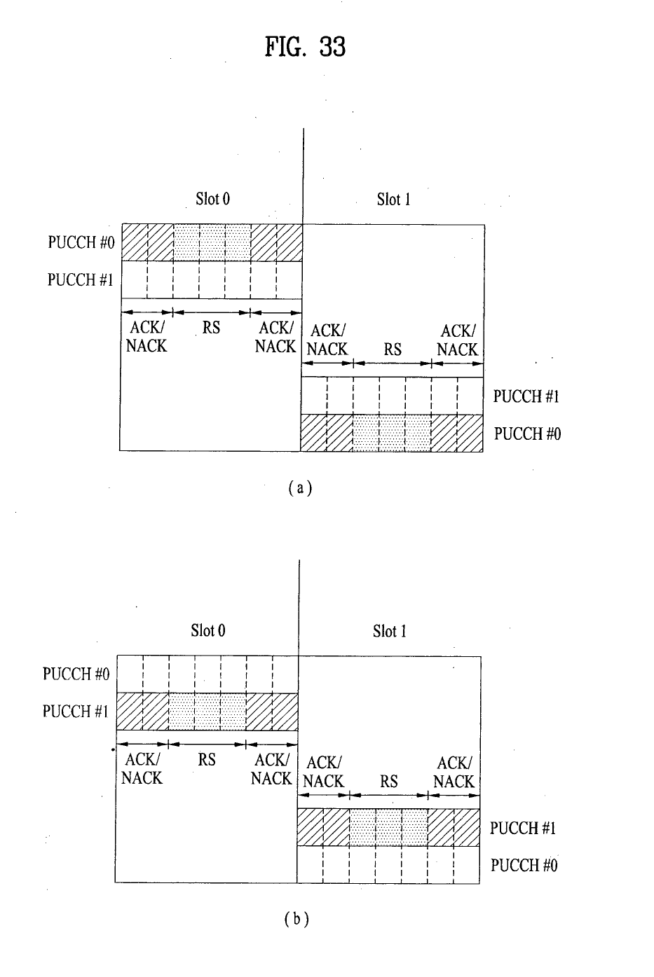

FIG. 33 is a diagram for a transmission structure of ACK/NACK information using channel selection according to the present invention.

Referring to FIG. 33, for PUCCH format 1b of 2-bit ACK/NACK information, 2 PUCCH resources or channels (e.g., PUCCH resource #0 and PUCCH resource #1, PUCCH channel #0 and PUCCH channel #1, etc.) may be set.

When 3-bit ACK/NACK information is transmitted, 2 bits of the 3-bit ACK/NACK information may be represented via PUCCH format 1b and the remaining 1 bit may be represented in a manner of selecting which one of the 2 PUCCH resources. For instance, in a manner of selecting either the case of transmitting the ACK/NACK information using. PUCCH resource #0 or the case of transmitting the ACK/NACK information using PUCCH resource #1, it may be able to represent 1 bit (i.e., 2 case types). Hence, it may be able to represent the ACK/NACK information of total 3 bits.

Table 11 shows one example of transmitting 3-bit ACK/NACK information using channel selection. For this example, assume a case that 2 PUCCH resources are set.

TABLE 11

| | Ch1 | | Ch2 | |
|---|---|---|---|---|
| ACK/NACK | RS | Data | RS | Data |
| N, N, N | 1 | 1 | 0 | 0 |
| N, N, A | 1 | −j | 0 | 0 |
| N, A, N | 1 | j | 0 | 0 |
| N, A, A | 1 | −1 | 0 | 0 |
| A, N, N | 0 | 0 | 1 | 1 |
| A, N, A | 0 | 0 | 1 | −j |
| A, A, N | 0 | 0 | 1 | j |
| A, A, A | 0 | 0 | 1 | −1 |

In Table 1, ‘A’ indicates ACK information, ‘N’ indicates NACK information or NACK/DTX information, and 1, −1, j, −j′ indicate 4 complex modulation symbols generated from QPSK modulation of 2-bit transmission information ‘b(0), b(1)’ transmitted in PUCCH format. In this case, the ‘b(0), b(1)’ corresponds to binary transmission bits carried using the selected PUCCH resource. For instance, the binary transmission bits ‘b(0), b(1)’ are mapped to complex modulation symbol by Table 12 and may be then carried on the PUCCH resource.

TABLE 12

| | Binary | Complex |
|---|---|---|
| | transmission bits | modulation |
| Modulation | b(0), b(1) | symbol |
| QPSK | 0, 0 | 1 |
| | 0, 1 | −j |
| | 1, 0 | J |
| | 1, 1 | −1 |

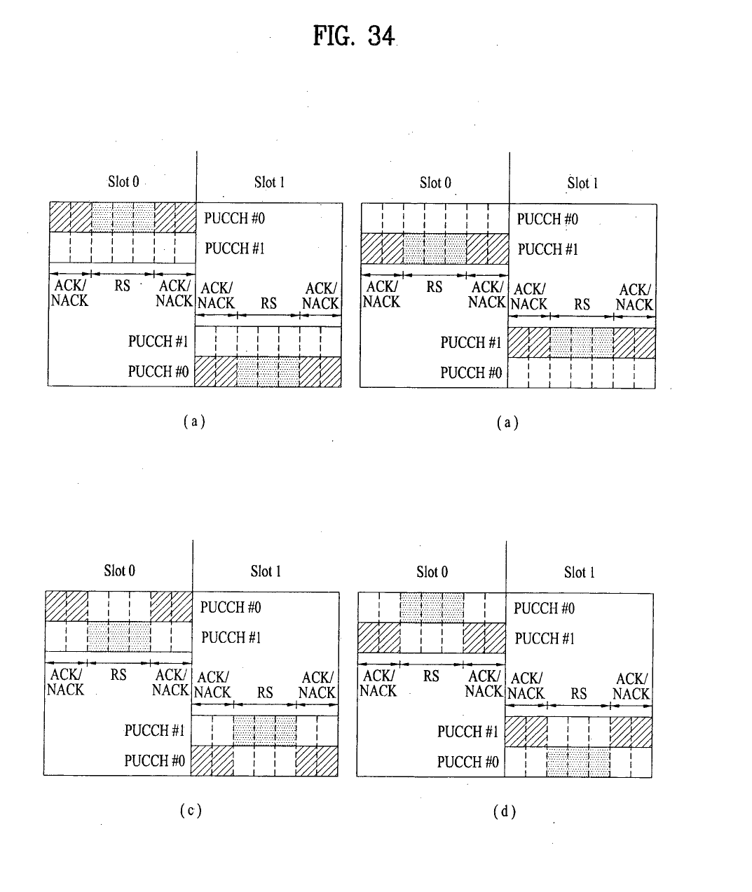

FIG. 34 is a diagram for a transmission structure of ACK/NACK information using enhanced channel selection according to the present invention. In particular, FIG. 34 shows PUCCH #0 and PUCCH #1 in different time/frequency domains, respectively, which is for clarity and convenience. Alternatively, PUCCH #0 and PUCCH #1 may be configured to use different codes in the same time/frequency domain, respectively.

Referring to FIG. 34, for PUCCH format 1a for transmission of 1-bit ACK/NACK information, 2 PUCCH resources (e.g., PUCCH resource #0 and PUCCH resource #1) may be set.

In case that 3-bit ACK/NACK information is transmitted, 1 bit of the 3-bit ACK/NACK information may be represented via PUCCH format 1a and another 1 bit may be represented in accordance with a fact that the ACK/NACK information is carried on which PUCCH resource (e.g., PUCCH resource #0 and PUCCH resource #1). And, the last 1 bit may be represented differently in accordance with whether a reference signal for a specific resource is transmitted. In this case, the reference signal may be preferably transmitted in time/frequency domain of a preferentially selected PUCCH resource (e.g., PUCCH resource #0 and PUCCH resource #1). Alternatively, the reference signal may be transmitted in time/frequency domain for an original PUCCH resource.

Since 2 bits (i.e., 4 kinds of cases) may be represented by selecting one of a case of transmitting ACK/NACK information on PUCCH resource #0 and transmitting a reference signal for a resource corresponding to the PUCCH resource #0, a case of transmitting ACK/NACK information on PUCCH resource #1 and transmitting a reference signal for a resource corresponding to the PUCCH resource #1, a case of transmitting ACK/NACK information on PUCCH resource #0 and transmitting a reference signal for a resource corresponding to the PUCCH resource #1, and a case of transmitting ACK/NACK information on PUCCH resource #1 and transmitting a reference signal for a resource corresponding to the PUCCH resource #0, it may be able to represent ACK/NACK information of total 3 bits.

Table 13 shows one example of delivering 3-bit ACK/NACK information using enhanced channel selection. For this example, assume a case that 2 PUCCH resources are set.

TABLE 13

| | Ch1 | | Ch2 | |
|---|---|---|---|---|
| ACK/NACK | RS | Data | RS | Data |
| N, N, N | 1 | 1 | 0 | 0 |
| N, N, A | 1 | −1 | 0 | 0 |
| N, A, N | 0 | 1 | 1 | 0 |
| N, A, A | 0 | −1 | 1 | 0 |
| A, N, N | 1 | 0 | 0 | 1 |
| A, N, A | 1 | 0 | 0 | −1 |
| A, A, N | 0 | 0 | 1 | 1 |
| A, A, A | 0 | 0 | 1 | −1 |

Unlike Table 12 using the channel selection, Table 13 using the enhanced channel selection may be meaningful in implementing symbol mapped to PUCCH resource by BPSK modulation. Alternatively, unlike the example shown in Table 13, it may be able to implement complex symbol by QPSK modulation using PUCCH format 1b. In this case, the number of bits transmittable on the same PUCCH may be increased.

Although FIG. 33 or FIG. 34 takes the case of setting 2 PUCCH resources to transit 3-bit ACK/NACK information as example, the number of transmission bits of ACK/NACK information and the number of PUCCH resources may be set variously. And, it may be apparent that the sample principle is applicable to a case of transmitting other UL control information instead of ACK/NACK information or a case of transmitting both ACK/NACK information and other UL control information simultaneously.

Table 14 shows one example of setting 2 PUCCH resources and transmitting 6 ACK/NACK states using channel selection.

TABLE 14

| HARQ-ACK(0), HARQ-ACK(1) | n⁽¹⁾ _{PUCCH} | b(0), b(1) |
|---|---|---|
| ACK, ACK | n⁽¹⁾ _{PUCCH,1} | 1, 1 |
| ACK, NACK/DTX | n⁽¹⁾ _{PUCCH,0} | 0, 1 |
| NACK/DTX, ACK | n⁽¹⁾ _{PUCCH,1} | 0, 0 |
| NACK/DTX, NACK | n⁽¹⁾ _{PUCCH,1} | 1, 0 |
| NACK, DTX | n⁽¹⁾ _{PUCCH,0} | 1, 0 |
| DTX, DTX | N/A | N/A |

Table 15 shows one example of setting 3 PUCCH resources and transmitting 11 ACK/NACK states using channel selection.

TABLE 15

| HARQ-ACK(0), HARQ-ACK(1), | | |
|---|---|---|
| HARQ-ACK(2) | n⁽¹⁾ _{PUCCH} | b(0), b(1) |
| ACK, ACK, ACK | n⁽¹⁾ _{PUCCH,2} | 1, 1 |
| ACK, ACK, NACK/DTX | n⁽¹⁾ _{PUCCH,1} | 1, 1 |
| ACK, NACK/DTX, ACK | n⁽¹⁾ _{PUCCH,0} | 1, 1 |
| ACK, NACK/DTX, NACK/DTX | n⁽¹⁾ _{PUCCH,0} | 0, 1 |
| NACK/DTX, ACK, ACK | n⁽¹⁾ _{PUCCH,2} | 1, 0 |
| NACK/DTX, ACK, NACK/DTX | n⁽¹⁾ _{PUCCH,1} | 0, 0 |
| NACK/DTX, NACK/DTX, ACK | n⁽¹⁾ _{PUCCH,2} | 0, 0 |
| DTX, DTX, NACK | n⁽¹⁾ _{PUCCH,2} | 0, 1 |
| DTX, NACK, NACK/DTX | n⁽¹⁾ _{PUCCH,1} | 1, 0 |
| NACK, NACK/DTX, NACK/DTX | n⁽¹⁾ _{PUCCH,0} | 1, 0 |
| DTX, DTX, DTX | N/A | N/A |

Table 16 shows one example of setting 4 PUCCH resources and transmitting 20 ACK/NACK states using channel selection.

TABLE 16

| HARQ-ACK(0), HARQ-ACK(1), HARQ- | | |
|---|---|---|
| ACK(2), HARQ-ACK(3) | n⁽¹⁾ _{PUCCH} | b(0), b(1) |
| ACK, ACK, ACK, ACK | n⁽¹⁾ _{PUCCH,1} | 1, 1 |
| ACK, ACK. ACK, NACK/DTX | n⁽¹⁾ _{PUCCH,1} | 1, 0 |
| NACK/DTX, NACK/DTX, NACK, DTX | n⁽¹⁾ _{PUCCH,2} | 1, 1 |
| ACK, ACK, NACK/DTX, ACK | n⁽¹⁾ _{PUCCH,1} | 1, 0 |
| NACK, DTX, DTX, DTX | n⁽¹⁾ _{PUCCH,0} | 1, 0 |
| ACK, ACK, NACK/DTX, NACK/DTX | n⁽¹⁾ _{PUCCH,1} | 1, 0 |
| ACK, NACK/DTX, ACK, ACK | n⁽¹⁾ _{PUCCH,3} | 0, 1 |
| NACK/DTX, NACK/DTX, NACK/DTX, NACK | n⁽¹⁾ _{PUCCH,3} | 1, 1 |
| ACK, NACK/DTX, ACK, NACK/DTX | n⁽¹⁾ _{PUCCH,2} | 0, 1 |
| ACK, NACK/DTX, NACK/DTX, ACK | n⁽¹⁾ _{PUCCH,0} | 0, 1 |
| ACK, NACK/DTX, NACK/DTX, NACK/DTX | n⁽¹⁾ _{PUCCH,0} | 1, 1 |
| NACK/DTX, ACK, ACK, ACK | n⁽¹⁾ _{PUCCH,3} | 0, 1 |
| NACK/DTX, NACK, DTX, DTX | n⁽¹⁾ _{PUCCH,1} | 0, 0 |
| NACK/DTX, ACK, ACK, NACK/DTX | n⁽¹⁾ _{PUCCH,2} | 1, 0 |
| NACK/DTX, ACK, NACK/DTX, ACK | n⁽¹⁾ _{PUCCH,3} | 1, 0 |
| NACK/DTX, ACK, NACK/DTX, NACK/DTX | n⁽¹⁾ _{PUCCH,1} | 0, 1 |
| NACK/DTX, NACK/DTX, ACK, ACK | n⁽¹⁾ _{PUCCH,3} | 0, 1 |
| NACK/DTX, NACK/DTX, ACK, NACK/DTX | n⁽¹⁾ _{PUCCH,2} | 0, 0 |
| NACK/DTX, NACK/DTX, NACK/DTX, ACK | n⁽¹⁾ _{PUCCH,3} | 0, 0 |
| DTX, DTX, DTX, DTX | N/A | N/A |

Meanwhile, a user equipment may be able transmit BSR (buffer status report) to a base station. In this case, the BSR (buffer status report) plays a role in indicating a size of data available for transmission within a UL buffer of the user equipment. Hence, the user equipment may be able to transmit the BSR to the base station on PUSCH using a UL resource allocated via PDCCH.

The user equipment may be able to report CSI (channel state information) via PUCCH or PUSCH. In this case, the CSI (channel state information) may include such control information as CQI, PMI, RI and the like.

The CSI report from the user equipment may be performed periodically or aperiodically. When the periodic CSI and the aperiodic CSI are simultaneously transmitted in the same subframe, either the periodic CSI or the aperiodic CSI may be transmitted. For instance, the user equipment may be able to report the aperiodic CSI in the subframe only to the base station.

The aperiodic CSI report may be triggered by SCI Request field of the PDCCH or PDSCH received from the base station. In particular, the user equipment determines whether to transmit the aperiodic CSI report to correspond to a value of the CSI Request field. Table 17 shows one example of CSI request field for determining whether to trigger the aperiodic CSI transmission.

TABLE 17

| Value of CSI | |
|---|---|
| request field | Description |
| ‘00’ | No aperiodic CSI report is triggered |
| ‘01’ | Aperiodic CSI report is |
| | triggered for serving cell c |
| ‘10’ | Aperiodic CSI report is triggered |
| | for a 1^{st} set of serving cells |
| | configured by higher layers |
| ‘11’ | Aperiodic CSI report is triggered |
| | for a 2^{nd} set of serving cells |
| | configured by higher layers |

In this case, in case of attempting to report aperiodic CSI to the base station, the user equipment may be necessarily able to use the PUSCH.

When the aperiodic CSI is transmitted to the base station on PUSCH, data (e.g., transport block, UL-SCH, etc.) may be transmitted together with the aperiodic CSI. For example of the UL-SCH transmittable together with the aperiodic. CSI, the above-mentioned BSR (buffer status report) may be included.

Moreover, PUSCH to carry the aperiodic CSI may be configured with CSI information only without such data as transport block and the like. For instance, when the aperiodic CSI is triggered with PDSCH, if the number of RBs allocated to PUSCH is equal to or smaller than 4, the PUSCH may be configured with CSI information only. In particular, when the aperiodic CSI is triggered, if the number of the RBs allocated to the PUSCH is equal to or smaller than 4, the PUSCH may be considered as configured with CSI only without other data or transport block.

In the following description, a process for determining a physical UL control channel in connection with a CSI report procedure by a user equipment is explained in detail.

First of all, described is a case that at least one serving cell is set for a user equipment and that the user equipment is set not to transmit PUSCH and PUCCH simultaneously.

If a user equipment does not transmit PUSCH, it may be able to transmit UCI on PUCCH using Format 1/1a/1b/3 or Format 2/2a/2b.

If UCI (uplink control information) a user equipment intends to transmit is configured with a periodic CSI or an aperiodic CSI and HARQ-ACK, it may be able to transmit the UCI on PUSCH of a serving cell.

If UCI (uplink control information) a user equipment intends to transmit is configured with a periodic CSI and/or HARQ-ACK, when the user equipment transmits the UCI not on PUSCH of a primary cell (PCell) but on PUSCH of a secondary cell (SCell), it may be able to transmit the UCI on PUSCH of the secondary cell having a lowest SCELL index among at least one or more secondary cells.

Meanwhile, if at least one serving cell is set for a user equipment and the user equipment is set to simultaneously transmit PUSCH and PUCCH both, it may cause a problem that a simultaneous transmission event of PUSCH and PUCCH in the same subframe takes place.

According to a related art, in case that the simultaneous transmission of PUCCH and PUSCH occurs in the same subframe, transmission of PUSCH is set to be dropped. Yet, if the transmission of PUSCH in the same subframe is dropped, detection probability of information transmitted by a user equipment is lowered. Hence, it may cause a problem that system performance is degraded.

Accordingly, the present invention intends to provide an efficient transmission method to cope with a case that the simultaneous transmission of PUCCH and PUSCH occurs in the same subframe.

For clarity and convenience of the following description, assume that at least one serving cell is set for a user equipment and that the user equipment is set to transmit both PUSCH and PUCCH simultaneously.

Assume that CSI a user equipment attempts to transmit includes an aperiodic CSI and that PUSCH for carrying the aperiodic CSI is configured with CSI information only without such data as transport block and the like, by which the present invention may be non-limited. And, it is apparent that various implementations thereof are possible.

In this case, as mentioned in the foregoing description, the aperiodic CSI is transmitted on PSUCH to a base station. Moreover, as mentioned in the foregoing description, the fact that the PUSCH for carrying the aperiodic CSI is configured with the CSI information without such data as transport block and the like may be provided if the number of RBs allocated to the PUSCH is equal to or smaller than 4 in case of triggering the aperiodic CSI with PDSCH.

Information a user equipment attempts to transmit on PUCCH is. UCI (uplink control information) and the UCI transmitted on the PUCCH may be named ‘UCI on PUCCH’.

In particular, assume that a user equipment transmits ‘UCI on PUCCH’ via PUCCH and that the user equipment transmits an aperiodic CSI via PUSCH.

According to one embodiment of the present invention, a user equipment may be able to transmit both PUSCH and PUCCH in the same subframe without dropping a transmission of PUSCH in the same subframe.

For instance, in case that ‘UCI on PUCCH’ a user equipment attempts to transit includes HARQ-ACK/HARQ ACK and SR/positive SR, the HARQ-ACK/HARQ ACK and SR/positive SR may be transmitted on PUCCH using Format 1/1a/1b/3 and aperiodic CSI and BSR (buffer status report) may be transmitted on PUSCH of a service cell.

The aforesaid embodiments of the present invention may be applicable to various UL control information transmissions. By applying the same principle, SR information and the number of ACK/NACK informations may be variously applicable as well. And, it may be apparent that a new control information transmitting method may be derived by combining a plurality of the embodiments together. Moreover, it may be apparent that transmission bits of the corresponding embodiment may be applicable to control information transmissions of various embodiments.

The above-described embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment. And, it is apparently understandable that a new embodiment may be configured by combining claims failing to have relation of explicit citation in the appended claims together or may be included as new claims by amendment after filing an application.

In this disclosure, embodiments of the present invention are described centering on the signal transceiving relation between a base station and a user equipment. This transceiving relation may be identically or similarly extensible to signal transceivings between a user equipment and a relay or between a base station and a relay. In this disclosure, a specific operation explained as performed by a base station may be performed by an upper node of the base station in some cases. In particular, in a network constructed with a plurality of network nodes including a base station, it is apparent that various operations performed for communication with a user equipment may be performed by a base station or other networks except the base station. In this case, ‘base station’ can be replaced by such a terminology as a fixed station, a Node B, an eNode B (eNB), an access point and the like. And, ‘terminal’ may be replaced by such a terminology as a user equipment (UE), a mobile station (MS), a mobile subscriber station (MSS)’ and the like.

Embodiments of the present invention may be implemented using various means. For instance, embodiments of the present invention may be implemented using hardware, firmware, software and/or any combinations thereof. In case of the implementation by hardware, one embodiment of the present invention may be implemented by one of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, one embodiment of the present invention may be implemented by modules, procedures, and/or functions for performing the above-explained functions or operations. Software code may be stored in a memory unit and may be then drivable by a processor. The memory unit may be provided within or outside the processor to exchange data with the processor through the various means known to the public.

As mentioned in the foregoing description, the detailed descriptions for the preferred embodiments of the present invention may be provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. Thus, the present invention may be non-limited by the embodiments disclosed herein but intends to give a broadest scope matching the principles and new features disclosed herein.

### INDUSTRIAL APPLICABILITY

As mentioned in the foregoing description, a method of transmitting control information in a wireless communication system and apparatus therefor may be described with reference to an example applied to 3GPP LTE system. Moreover, the present invention may be applicable to various mobile communication systems as well as to the 3GPP LTE system.

What is claimed is:

1. A method for transmitting control information to a base station by a user equipment in a wireless communication system, the method comprising:
receiving a PDCCH (physical downlink control channel) including a CSI (channel state information) request field from the base station via at least one serving cell configured for the user equipment;
triggering a report of a 1^{st} control information on an aperiodic CSI according to a value of the received CSI request field; and
transmitting the 1^{st} control information and a 2^{nd} control information in a same subframe simultaneously,
wherein the 1^{st} control information is transmitted on a PUSCH (physical uplink shared channel) of the at least one serving cell and
wherein the 2^{nd} control information is transmitted on a PUCCH (physical uplink control channel) of the at least one serving cell.

2. The method of claim 1, wherein the PUSCH of the at least one serving cell comprises the 1^{st} control information only without a transport block.

3. The method of claim 1, wherein the 2^{nd} control information comprises at least one selected from the group consisting of a scheduling request (SR) information, an HARQ acknowledgement (ACK) information and an HARQ negative acknowledgement (NACK) information.

4. The method of claim 1, wherein an information on a BSR (buffer status report) is transmitted on the PUSCH of the at least one serving cell together with the 1^{st} control information.

5. The method of claim 1, wherein if the 1^{st} control information, the 2^{nd} information and a 3^{rd} control information on a periodic CSI are simultaneously transmitted in the same subframe, the 1^{st} control information and the 2^{nd} control information are transmitted only.

6. The method of claim 1, wherein the 2^{nd} control information is transmitted using at least one of PUCCH Format 1, PUCCH Format 1a, PUCCH Format 1b and PUCCH Format 3.

7. A user equipment for transmitting control information to a base station in a wireless communication system, comprising:
a receiving module receiving a PDCCH (physical downlink control channel) including a CSI (channel state information) request field from the base station via at least one serving cell configured for the user equipment;
a processor controlling a report of a 1^{st} control information on an aperiodic CSI to be triggered according to a value of the received CSI request field; and
a transmitting module transmitting the 1^{st} control information and a 2^{nd} control information in a same subframe simultaneously,
wherein the processor controls the 1^{st} control information to be transmitted on a PUSCH (physical uplink shared channel) of the at least one serving cell and
wherein the controller controls the 2^{nd} control information to be transmitted on a PUCCH (physical uplink control channel) of the at least one serving cell.

8. The user equipment of claim 7, wherein the PUSCH of the at least one serving cell comprises the 1^{st} control information only without a transport block.

9. The user equipment of claim 7, wherein the 2^{nd} control information comprises at least one selected from the group consisting of a scheduling request (SR) information, an HARQ acknowledgement (ACK) information and an HARQ negative acknowledgement (NACK) information.

10. The user equipment of claim 7, wherein the processor controls an information on a BSR (buffer status report) to be transmitted on the PUSCH of the at least one serving cell together with the 1^{st} control information.

11. The user equipment of claim 7, wherein if the 1^{st} control information, the 2^{nd} information and a 3^{rd} control information on a periodic CSI are, simultaneously transmitted in the same subframe, the processor controls the 1^{st} control information and the 2^{nd} control information to be transmitted only.

12. The user equipment of claim 7, wherein the 2^{nd} control information is transmitted using at least one of PUCCH Format 1, PUCCH Format 1a, PUCCH Format 1b and PUCCH Format 3.
